(19) United States
(12) Patent Application Publication
(10) Pub. No.: US 2026/0371197 A1
(43) Pub. Date: Nov. 19, 2026

(54) OPERATION METHOD OF APPARATUS COMPRISING PLURALITY OF BEAM PANELS IN WIRELESS COMMUNICATION SYSTEM, AND APPARATUS USING SAID METHOD

(71) Applicant: LG ELECTRONICS INC., Seoul (KR)

(72) Inventors: Kwansoo KIM, Seoul (KR); Soojin KIM, Seoul (KR)

(73) Assignee: LG ELECTRONICS INC., Seoul (KR)

(21) Appl. No.: 19/135,714

(22) PCT Filed: Dec. 8, 2022
(86) PCT No.: PCT/KR2022/019891

§ 371 Date: Jun. 4, 2025

(51) Int. Cl. H04W 36/08; H04B 7/0404; H04W 36/00; H04W 74/0833; H04W 88/08

(52) U.S. Cl. CPC H04W 36/085; H04B 7/0404; H04W 36/0072; H04W 74/0833; H04W 88/085

(57) ABSTRACT

Provided are an operation method of an apparatus comprising a plurality of beam panels in a wireless communication system, and an apparatus using the method. The method comprises: providing a base station with UE capability information including beam related information, and the current beam panel and beam index information; and being provided with estimated information from the base station. This UE may perform a beam search on the basis of a beam panel and a beam index that have been determined on the basis of the estimated information.

### CROSS-REFERENCE TO RELATED APPLICATION(S)

This application is the National Stage filing under 35 U.S.C. 371 of International Application No. PCT/KR2022/019891, filed on Dec. 8, 2022, the contents of which is hereby incorporated by reference herein in its entirety.

### TECHNICAL FIELD

The present disclosure relates to wireless communications, and more particularly, to a method of operating a device including a plurality of beam panels and a device utilizing the method.

### BACKGROUND

As more and more communication devices require more communication capacity, there is a need for improved mobile broadband communication over existing radio access technology. Also, massive machine type communications (MTC), which provides various services by connecting many devices and objects, is one of the major issues to be considered in the next generation communication. In addition, communication system design considering reliability/latency sensitive service/UE is being discussed. The introduction of next generation radio access technology considering enhanced mobile broadband communication (eMBB), massive MTC (mMTC), ultra-reliable and low latency communication (URLLC) is discussed.

In the next generation of wireless access technologies, terahertz (THz) or millimeter wave (mmWave) may be used. In THz or mmWave operations, the process of beam tracking for mutual beam alignment between transmit and receive is essential, and channel estimation for this purpose incurs overhead and time in terms of radio resources.

Future terminals may include antennas that include multiple beam panels. As the number of beam panels mounted on a terminal increases, the time for the terminal to perform beam search and beam alignment in relation to a specific transmit-receive point (TRP) will increase. This, in turn, will reduce the efficiency of communication and increase the power consumption of the device.

In addition, when a terminal performs a handover from the first TRP to the second TRP, the time for beam search and beam alignment, as well as unnecessary power consumption of the terminal, will increase.

When operating in THz or mmWave, a method and device for efficiently operating a terminal having a multi-beam panel are required.

### SUMMARY

The technical problem to be solved through the present disclosure is to provide a method of operating a device including a plurality of beam panels in a wireless communication system and a device using the method.

In one aspect, a method of operating a user equipment (UE) including a plurality of beam panels in a wireless communication system is provided. The method is characterized in that the UE performs an initial access procedure with a base station, and transmits UE capability information for a beam capability of the UE to the base station, wherein the UE capability information includes beam related information for each of the plurality of beam panels, reports information for a current beam panel and a current beam index used by the UE in a relationship with a first TRP (transmit-receive point) among the plurality of beam panels to the base station, receives estimated information for a specific beam panel among the plurality of beam panels and a specific beam index from the base station, and performs a beam search in a relationship with a second TRP, preferentially performing a beam search procedure for the specific beam panel among the plurality of beam panels.

In another aspect, a UE for performing the method is provided. The UE includes a transceiver, a processor connected to the transceiver, and a memory operably connected to the processor, wherein the processor performs the method.

In another aspect, a processing device for controlling the UE is provided. The processing device may be a chipset including one or more processors and one or more memories operably connected to the one or more processors, and the processors perform the method.

In another aspect, a computer readable medium (CRM) is provided that stores instructions causing operations to be performed by one or more processors. The method can be performed by the CRM.

In another aspect, a method performed by a base station is provided. The method comprises: performing an initial access procedure with a UE; receiving UE capability information for a beam capability of the UE from the UE, wherein the UE capability information includes beam related information for each of a plurality of beam panels of the UE; receiving, from the UE, information for a current beam panel among the plurality of beam panels and a current beam index used by the UE in a relationship with a first TRP (transmit-receive point); and transmitting to the UE estimated information for a specific beam panel among the plurality of beam panels and a specific beam index, wherein the specific beam panel and the specific beam index are a beam panel and a beam to be applied to the UE in the future in a relationship between the UE and a second TRP, which are estimated by the base station based on the UE capability information, the current beam panel, and the current beam index.

In another aspect, provided is a base station including one or more transceivers, one or more processors, and one or more memories operably connected to the one or more processors, wherein the one or more processors perform the method.

The beam search and optimal beam selection time of a UE including multiple beam panels can be reduced to improve the efficiency of communication, thereby reducing the power consumption of the UE.

### BRIEF DESCRIPTION OF THE DRAWINGS

FIG. 1 shows a wireless communication system.

FIG. 2 is a diagram showing a wireless protocol architecture for a user plane.

FIG. 3 is a diagram showing a wireless protocol architecture for a control plane.

FIG. 4 illustrates a system structure of a next generation radio access network (NG-RAN) to which NR is applied.

FIG. 5 illustrates a functional division between an NG-RAN and a 5GC.

FIG. 6 illustrates physical channels and general signal transmission.

FIG. 7 illustrates an example of a frame structure that may be applied in NR.

FIG. 8 illustrates a slot structure of an NR frame.

FIG. 9 illustrates CORESET.

FIG. 10 is a diagram illustrating a difference between a related art control region and the CORESET in NR.

FIG. 11 illustrates an example of a frame structure for new radio access technology.

FIG. 12 illustrates a structure of a self-contained slot.

FIG. 13 is an abstract diagram of a hybrid beamforming structure from the viewpoint of the TXRU and the physical antenna.

FIG. 14 is a diagram illustrating a beam sweeping operation for a synchronization signal and system information in a downlink (DL) transmission process.

FIG. 15 is a diagram schematically illustrating a transmission beam sweeping process of a base station and a reception beam tracking process of a receiving UE for conventional beam search.

FIG. 16 shows an example of SSB resource allocation of a base station.

FIG. 17 illustrates an initial access procedure of a UE including a beam search process in NR.

FIG. 18 illustrates a beam failure detection process between a UE and a base station in NR.

FIG. 19 illustrates a beam failure recovery process between a UE and a base station in NR.

FIG. 20 illustrates a response process of a UE to a request for UE capability information from a base station after an initial beam search.

FIG. 21 illustrates a UE equipped with a beam panel for beam transmission and reception.

FIG. 22 illustrates beam related information.

FIG. 23 illustrates movement of a UE equipped with multi-beam panels in a short-range TRP environment.

FIG. 24 illustrates a link addition method by a fast additional beam search of a multi-beam panel UE.

FIG. 25 illustrates movement of a UE equipped with multi-beam panels in a long-range TRP environment.

FIG. 26 illustrates the signaling process related to the process of a UE equipped with multi-beam panels performing beam reselection (handover between TRPs) in a long-range TRP environment.

FIG. 27 illustrates the beam prediction process.

FIG. 28 illustrates the beam prediction process.

FIG. 29 illustrates an operation method of a UE including a plurality of beam panels in a wireless communication system according to the present disclosure.

FIG. 30 illustrates a method performed by a base station in a wireless communication system according to one embodiment of the present disclosure.

FIG. 31 illustrates a wireless device applicable to the present disclosure.

FIG. 32 shows an example of a structure of a signal processing module in a transmitter.

FIG. 33 shows another example of a structure of a signal processing module in a transmitter.

FIG. 34 illustrates an example of a wireless communication device for implementing the present disclosure.

FIG. 35 shows another example of a wireless device applied to the present disclosure.

FIG. 36 illustrates a communication system 1 applied to the present disclosure.

### DETAILED DESCRIPTION

In the following disclosure, “/” and “,” should be interpreted as indicating “and/or”. For example, “A/B” may refer to “A and/or B”. “A, B” may refer to “A and/or B”. “A/B/C” may refer to “at least one of A, B, and/or C”. “A, B, C” may refer to “at least one of A, B, and/or C”.

In the following disclosure, “or” should be interpreted as indicating “and/or”. For example, “A or B” may include “only A”, “only B”, and/or “both A and B”. In other words, in the following disclosure, “or” should be interpreted as indicating “additionally or alternatively”.

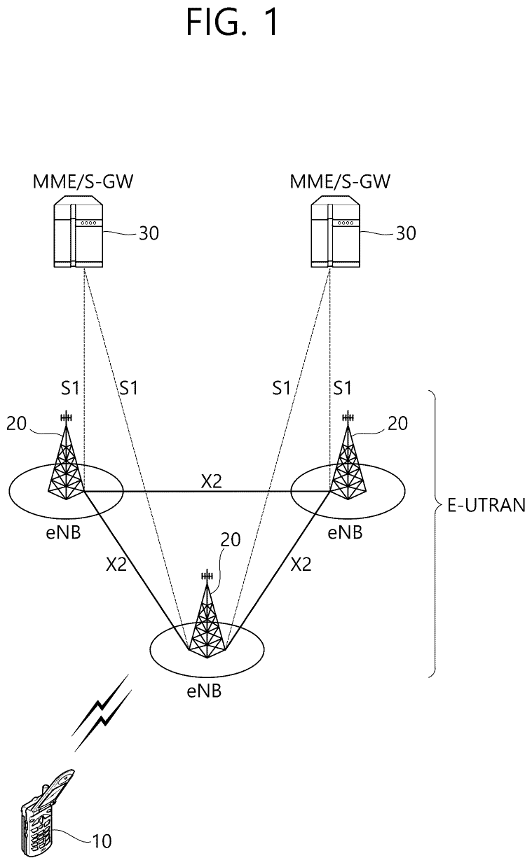

FIG. 1 shows a wireless communication system to which the present disclosure may be applied. The wireless communication system may be referred to as an Evolved-UMTS Terrestrial Radio Access Network (E-UTRAN) or a Long Term Evolution (LTE)/LTE-A system.

The E-UTRAN includes at least one base station (BS) 20 which provides a control plane and a user plane to a user equipment (UE) 10. The UE 10 may be fixed or mobile, and may be referred to as another terminology, such as a mobile station (MS), a user terminal (UT), a subscriber station (SS), a mobile terminal (MT), a wireless device, a terminal, a mobile node, etc. The BS 20 is generally a fixed station that communicates with the UE 10 and may be referred to as another terminology, such as an evolved node-B (eNB), a base transceiver system (BTS), an access point, a fixed node, etc.

The BSs 20 are interconnected by means of an X2 interface. The BSs 20 are also connected by means of an S1 interface to an evolved packet core (EPC) 30, more specifically, to a mobility management entity (MME) through S1-MME and to a serving gateway (S-GW) through S1-U.

The EPC 30 includes an MME, an S-GW, and a packet data network-gateway (P-GW). The MME has access information of the UE or capability information of the UE, and such information is generally used for mobility management of the UE. The S-GW is a gateway having an E-UTRAN as an end point. The P-GW is a gateway having a PDN as an end point.

Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

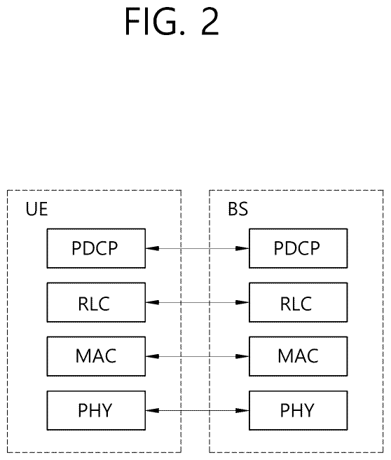

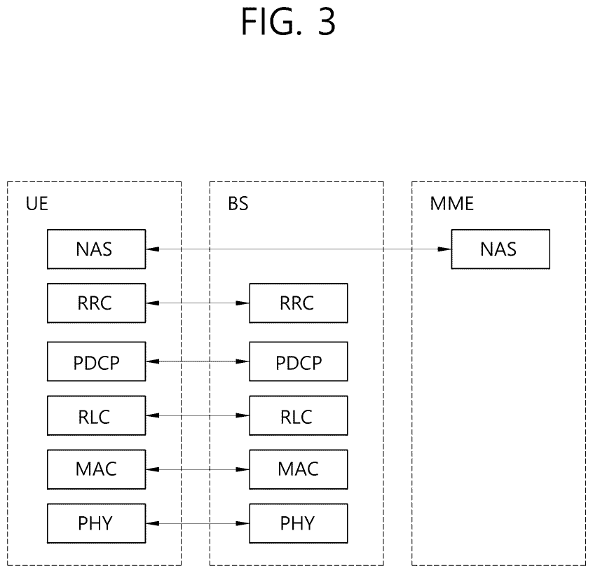

FIG. 2 is a diagram showing a wireless protocol architecture for a user plane. FIG. 3 is a diagram showing a wireless protocol architecture for a control plane. The user plane is a protocol stack for user data transmission. The control plane is a protocol stack for control signal transmission.

Referring to FIGS. 2 and 3, a PHY layer provides an upper layer (=higher layer) with an information transfer service through a physical channel. The PHY layer is connected to a medium access control (MAC) layer which is an upper layer of the PHY layer through a transport channel. Data is transferred between the MAC layer and the PHY layer through the transport channel. The transport channel is classified according to how and with what characteristics data is transferred through a radio interface.

Data is moved between different PHY layers, that is, the PHY layers of a transmitter and a receiver, through a physical channel. The physical channel may be modulated according to an Orthogonal Frequency Division Multiplexing (OFDM) scheme, and use the time and frequency as radio resources.

The functions of the MAC layer include mapping between a logical channel and a transport channel and multiplexing and demultiplexing to a transport block that is provided through a physical channel on the transport channel of a MAC Service Data Unit (SDU) that belongs to a logical channel. The MAC layer provides service to a Radio Link Control (RLC) layer through the logical channel.

The functions of the RLC layer include the concatenation, segmentation, and reassembly of an RLC SDU. In order to guarantee various types of Quality of Service (QoS) required by a Radio Bearer (RB), the RLC layer provides three types of operation mode: Transparent Mode (TM), Unacknowledged Mode (UM), and Acknowledged Mode (AM). AM RLC provides error correction through an Automatic Repeat Request (ARQ).

The RRC layer is defined only on the control plane. The RRC layer is related to the configuration, reconfiguration, and release of radio bearers, and is responsible for control of logical channels, transport channels, and PHY channels. An RB means a logical route that is provided by the first layer (PHY layer) and the second layers (MAC layer, the RLC layer, and the PDCP layer) in order to transfer data between UE and a network.

The function of a Packet Data Convergence Protocol (PDCP) layer on the user plane includes the transfer of user data and header compression and ciphering. The function of the PDCP layer on the user plane further includes the transfer and encryption/integrity protection of control plane data.

What an RB is configured means a process of defining the characteristics of a wireless protocol layer and channels in order to provide specific service and configuring each detailed parameter and operating method. An RB can be divided into two types of a Signaling RB (SRB) and a Data RB (DRB). The SRB is used as a passage through which an RRC message is transmitted on the control plane, and the DRB is used as a passage through which user data is transmitted on the user plane.

If RRC connection is established between the RRC layer of UE and the RRC layer of an E-UTRAN, the UE is in the RRC connected state. If not, the UE is in the RRC idle state.

A downlink transport channel through which data is transmitted from a network to UE includes a broadcast channel (BCH) through which system information is transmitted and a downlink shared channel (SCH) through which user traffic or control messages are transmitted. Traffic or a control message for downlink multicast or broadcast service may be transmitted through the downlink SCH, or may be transmitted through an additional downlink multicast channel (MCH). Meanwhile, an uplink transport channel through which data is transmitted from UE to a network includes a random access channel (RACH) through which an initial control message is transmitted and an uplink shared channel (SCH) through which user traffic or control messages are transmitted.

Logical channels that are placed over the transport channel and that are mapped to the transport channel include a broadcast control channel (BCCH), a paging control channel (PCCH), a common control channel (CCCH), a multicast control channel (MCCH), and a multicast traffic channel (MTCH).

The physical channel includes several OFDM symbols in the time domain and several subcarriers in the frequency domain. One subframe includes a plurality of OFDM symbols in the time domain. An RB is a resources allocation unit, and includes a plurality of OFDM symbols and a plurality of subcarriers. Furthermore, each subframe may use specific subcarriers of specific OFDM symbols (e.g., the first OFDM symbol) of the corresponding subframe for a physical downlink control channel (PDCCH), that is, an L1/L2 control channel. A Transmission Time Interval (TTI) is a unit time for subframe transmission.

Hereinafter, a new radio access technology (new RAT, NR) will be described.

As more and more communication devices require more communication capacity, there is a need for improved mobile broadband communication over existing radio access technology. Also, massive machine type communications (MTC), which provides various services by connecting many devices and objects, is one of the major issues to be considered in the next generation communication. In addition, communication system design considering reliability/latency sensitive service/UE is being discussed. The introduction of next generation radio access technology considering enhanced mobile broadband communication (eMBB), massive MTC (mMTC), ultrareliable and low latency communication (URLLC) is discussed. This new technology may be called new radio access technology (new RAT or NR) in the present disclosure for convenience.

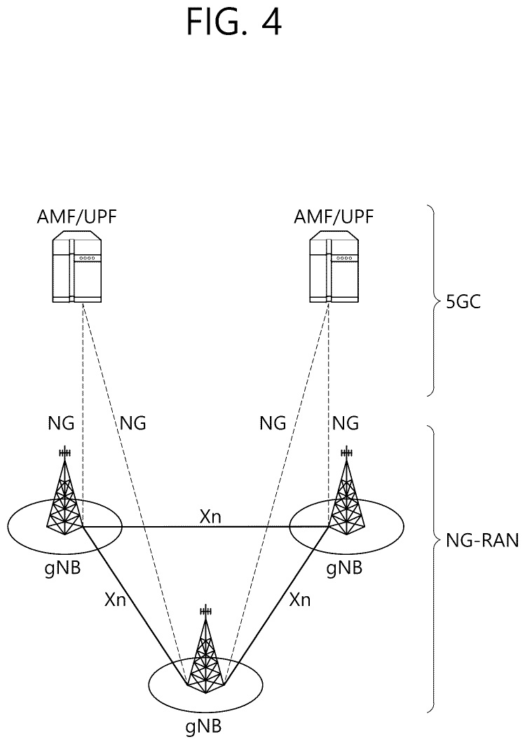

FIG. 4 illustrates a system structure of a next generation radio access network (NG-RAN) to which NR is applied.

Referring to FIG. 4, the NG-RAN may include a gNB and/or an eNB that provides user plane and control plane protocol termination to a terminal. FIG. 4 illustrates the case of including only gNBs. The gNB and the eNB are connected by an Xn interface. The gNB and the eNB are connected to a 5G core network (5GC) via an NG interface. More specifically, the gNB and the eNB are connected to an access and mobility management function (AMF) via an NG-C interface and connected to a user plane function (UPF) via an NG-U interface.

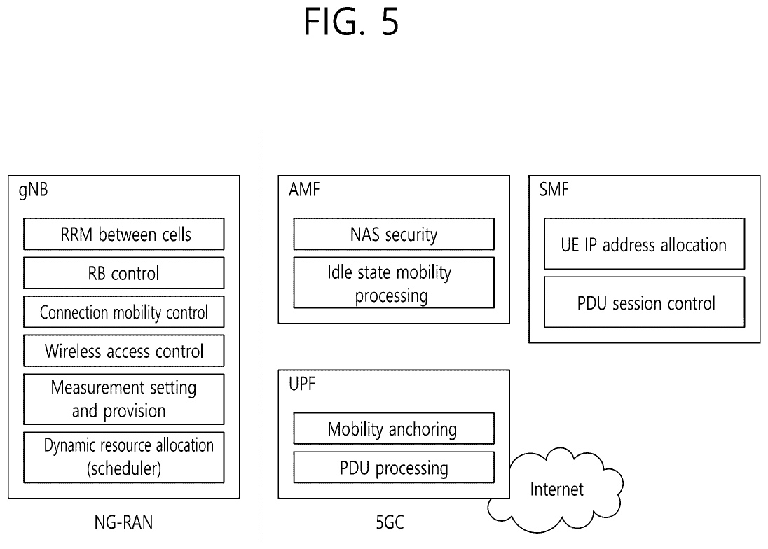

FIG. 5 illustrates a functional division between an NG-RAN and a 5GC.

Referring to FIG. 5, the gNB may provide functions such as an inter-cell radio resource management (Inter Cell RRM), radio bearer management (RB control), connection mobility control, radio admission control, measurement configuration & provision, dynamic resource allocation, and the like. The AMF may provide functions such as NAS security, idle state mobility handling, and so on. The UPF may provide functions such as mobility anchoring, PDU processing, and the like. The SMF may provide functions such as UE IP address assignment, PDU session control, and so on.

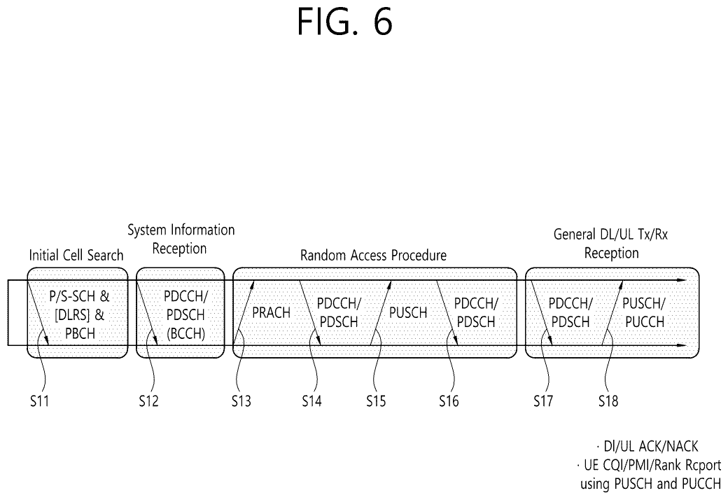

FIG. 6 illustrates physical channels and general signal transmission.

Referring to FIG. 6, in a wireless communication system, a user equipment (UE) (or terminal) receives information from a base station (BS) through a downlink (DL), and the UE transmits information to a BS through an uplink (UL). Information transmitted and received by the base station and the UE includes data and various control information, and various physical channels exist according to types/purposes of information transmitted and received by the BS and the UE.

When power is turned on again in a state where power was turned off or when the UE newly enters a cell, the UE performs an initial cell search operation such as synchronizing with the BS (S11). To this end, the UE is synchronized with the BS upon receiving a primary synchronization channel (PSCH) and a secondary synchronization channel (SSCH) from the BS, and acquires information such as cell identity (cell ID). In addition, the UE may acquire intra-cell broadcast information upon receiving a physical broadcast channel (BPCH) from the BS. In addition, the UE may check a downlink channel state upon receiving a downlink reference signal (DL RS) in an initial cell search step.

After completing the initial cell search, the UE may acquire more detailed system information upon receiving a physical downlink control channel (PDCCH) and a physical downlink control channel (PDSCH) corresponding thereto (S12).

Thereafter, the UE may perform a random access procedure to complete access to the BS (S13 to S16). Specifically, the UE may transmit a preamble through a physical random access channel (PRACH) (S13) and receive a random access response (RAR) for the preamble through a PDCCH and a PDSCH corresponding thereto (S14). Thereafter, the UE may transmit a physical uplink shared channel (PUSCH) using scheduling information in the RAR (S15) and perform a contention resolution procedure such as the PDCCH and the corresponding PDSCH (S16).

After performing the aforementioned procedure, the UE may perform PDCCH/PDSCH reception (S17) and PUSCH/physical uplink control channel (PUCCH) transmission (S18) as a general uplink/downlink signal transmission procedure. Control information transmitted by the UE to the BS is referred to as uplink control information (UCI). The UCI may include a hybrid automatic and request (HARQ) acknowledgement/negative-acknowledgement/negative (ACK NACK), a scheduling request (SR), channel state information (CSI), and the like. The CSI may include a channel quality indicator (CQI), a precoding matrix indicator (PMI), a rank indication (RI), and the like. The UCI is generally transmitted through the PUCCH, but may be transmitted through PUSCH when control information and data are to be transmitted at the same time. In addition, the UE may aperiodically transmit the UCI through the PUSCH according to a request/instruction of a network.

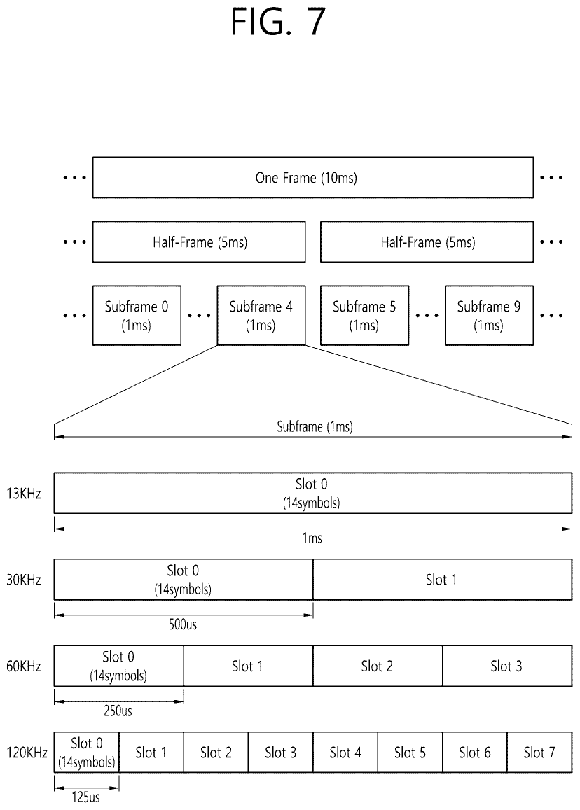

FIG. 7 illustrates a frame structure that may be applied in NR.

Referring to FIG. 7, a frame may consist of 10 milliseconds (ms) and may include 10 subframes consisting of 1 ms.

A subframe may include one or a plurality of slots according to a subcarrier spacing (SCS).

The following table 1 illustrates a subcarrier spacing configuration u.

TABLE 1

| μ | Δf = 2^{μ} · 15[kHz] | Cyclic prefix |
|---|---|---|
| 0 | 15 | Normal |
| 1 | 30 | Normal |
| 2 | 60 | Normal Extended |
| 3 | 120 | normal |
| 4 | 240 | normal |

Table 1-1 below illustrates the number of symbols per slot, the number of slots per frame, and the number of slots per subframe depending on the SCS, in case of using an extended CP.

TABLE 1-1

| μ | N^{slot}_{symb} | N^{frame, u}ₛₗₒₜ | N^{subframe, u}ₛₗₒₜ |
|---|---|---|---|
| 2 | 12 | 40 | 4 |

The following table 2 illustrates the number of slots in a frame (N^{frame,μ}ₛₗₒₜ), the number of slots in a subframe (N^{subframe,μ}ₛₗₒₜ), the number of symbols in a slot (N^{slots}_{symb}), and the like, according to subcarrier spacing configurations u.

TABLE 2

| μ | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

FIG. 7 illustrates a case of μ=0, 1, 2, 3.

A physical downlink control channel (PDCCH) may include one or more control channel elements (CCE) as shown in Table 3 below.

TABLE 3

| Aggregation level | Number of CCEs |
|---|---|
| 1 | 1 |
| 2 | 2 |
| 4 | 4 |
| 8 | 8 |
| 16 | 16 |

That is, the PDCCH may be transmitted through a resource consisting of 1, 2, 4, 8, or 16 CCEs. Here, the CCE includes six resource element groups (REGs), and one REG includes one resource block in the frequency domain and one orthogonal frequency division multiplexing (OFDM) symbol in the time domain.

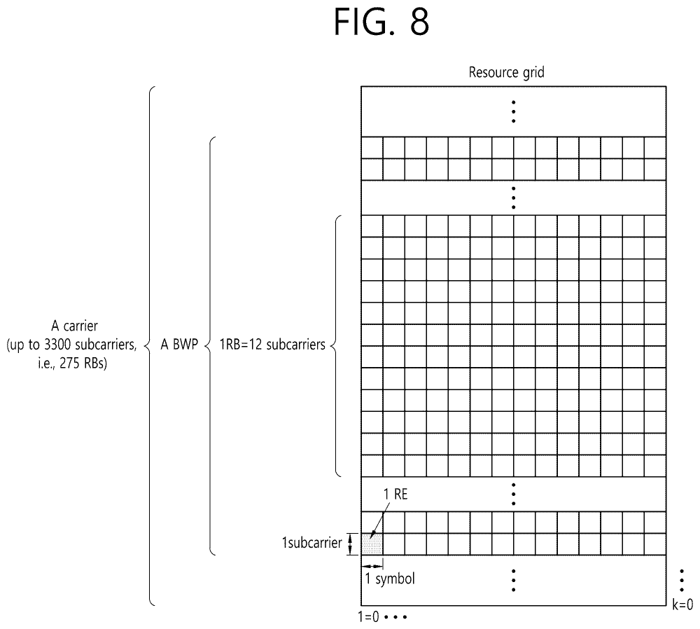

FIG. 8 illustrates a slot structure of an NR frame.

A slot may include a plurality of symbols in a time domain. For example, in case of a normal CP, one slot may include 7 symbols. However, in case of an extended CP, one slot may include 6 symbols. A carrier may include a plurality of subcarriers in a frequency domain. A resource block (RB) may be defined as a plurality of consecutive subcarriers (e.g., 12 subcarriers) in the frequency domain. A bandwidth part (BWP) may be defined as a plurality of consecutive (physical) resource blocks ((P) RBs) in the frequency domain, and the BWP may correspond to one numerology (e.g., SCS, CP length, and so on). The carrier may include up to N (e.g., 5) BWPs. Data communication may be performed via an activated BWP, and only one BWP may be activated for one UE. In a resource grid, each element may be referred to as a resource element (RE), and one complex symbol may be mapped thereto.

Meanwhile, a new unit called a control resource set (CORESET) may be introduced in the NR. The UE may receive a PDCCH in the CORESET.

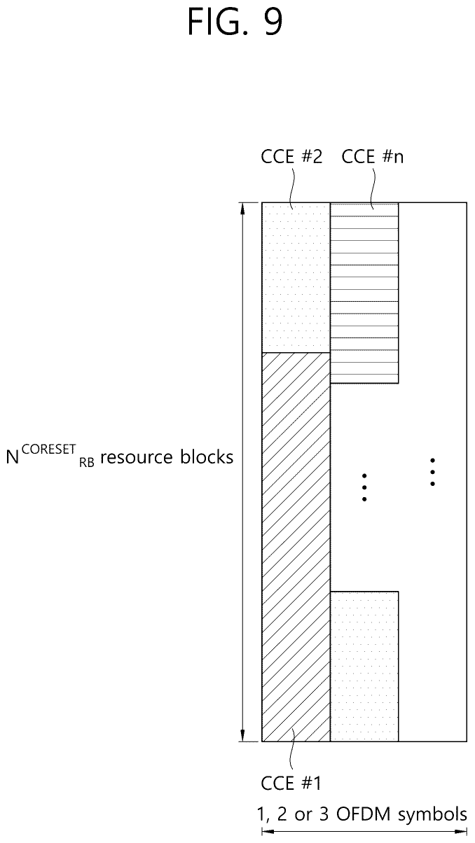

FIG. 9 illustrates CORESET.

Referring to FIG. 9, the CORESET includes N^{CORESET}_{RB} number of resource blocks in the frequency domain, and N^{CORESET}_{symb}∈{1, 2, 3} number of symbols in the time domain. N^{CORESET}_{RB} and N^{CORESET}_{symb} may be provided by a base station via higher layer signaling. As illustrated in FIG. 9, a plurality of CCEs (or REGs) may be included in the CORESET.

The UE may attempt to detect a PDCCH in units of 1, 2, 4, 8, or 16 CCEs in the CORESET. One or a plurality of CCEs in which PDCCH detection may be attempted may be referred to as PDCCH candidates. A plurality of CORESETs may be configured for the UE.

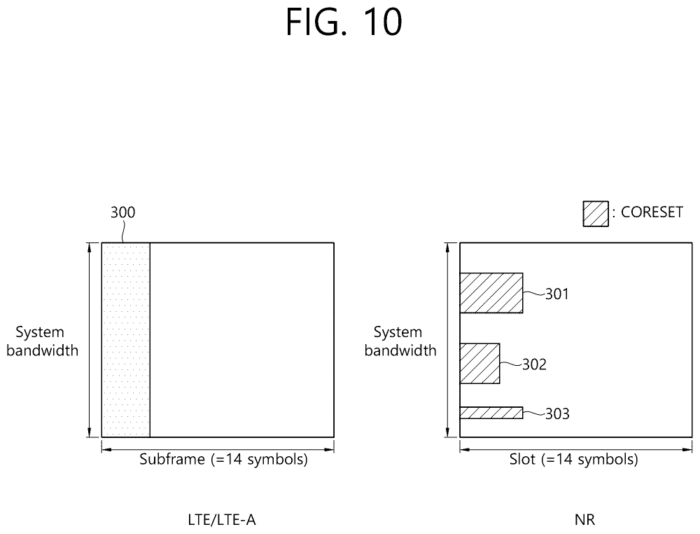

FIG. 10 is a diagram illustrating a difference between a related art control region and the CORESET in NR.

Referring to FIG. 10, a control region 300 in the related art wireless communication system (e.g., LTE/LTE-A) is configured over the entire system band used by a base station (BS). All the UEs, excluding some (e.g., eMTC/NB-IoT UE) supporting only a narrow band, should be able to receive wireless signals of the entire system band of the BS in order to properly receive/decode control information transmitted by the BS.

On the other hand, in NR, CORESET described above was introduced. CORESETs 301, 302, and 303 are radio resources for control information to be received by the UE and may use only a portion, rather than the entirety of the system bandwidth. The BS may allocate the CORESET to each UE and may transmit control information through the allocated CORESET. For example, in FIG. 10, a first CORESET 301 may be allocated to UE 1, a second CORESET 302 may be allocated to UE 2, and a third CORESET 303 may be allocated to UE 3. In the NR, the UE may receive control information from the BS, without necessarily receiving the entire system band.

The CORESET may include a UE-specific CORESET for transmitting UE-specific control information and a common CORESET for transmitting control information common to all UEs.

Meanwhile, NR may require high reliability according to applications. In such a situation, a target block error rate (BLER) for downlink control information (DCI) transmitted through a downlink control channel (e.g., physical downlink control channel (PDCCH)) may remarkably decrease compared to those of conventional technologies. As an example of a method for satisfying requirement that requires high reliability, content included in DCI can be reduced and/or the amount of resources used for DCI transmission can be increased. Here, resources can include at least one of resources in the time domain, resources in the frequency domain, resources in the code domain and resources in the spatial domain.

In NR, the following technologies/features can be applied.

### <Self-Contained Subframe Structure>

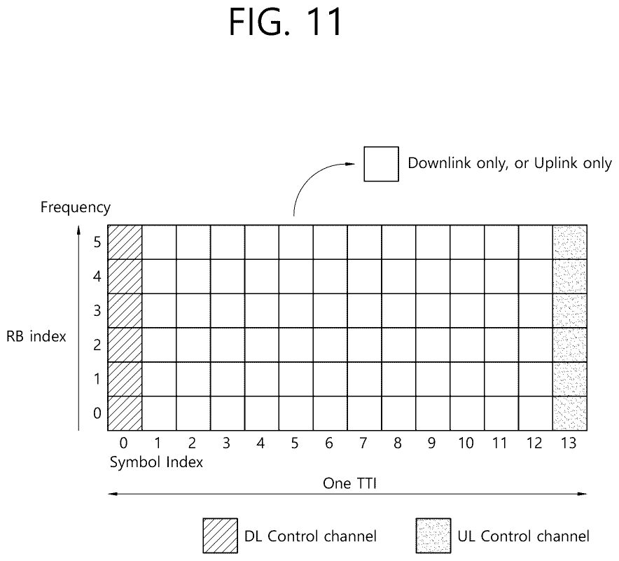

FIG. 11 illustrates an example of a frame structure for new radio access technology.

In NR, a structure in which a control channel and a data channel are time-division-multiplexed within one TTI, as shown in FIG. 11, can be considered as a frame structure in order to minimize latency.

In FIG. 11, a shaded region represents a downlink control region and a black region represents an uplink control region. The remaining region may be used for downlink (DL) data transmission or uplink (UL) data transmission. This structure is characterized in that DL transmission and UL transmission are sequentially performed within one subframe and thus DL data can be transmitted and UL ACK/NACK can be received within the subframe. Consequently, a time required from occurrence of a data transmission error to data retransmission is reduced, thereby minimizing latency in final data transmission.

In this data and control TDMed subframe structure, a time gap for a base station and a UE to switch from a transmission mode to a reception mode or from the reception mode to the transmission mode may be required. To this end, some OFDM symbols at a time when DL switches to UL may be set to a guard period (GP) in the self-contained subframe structure.

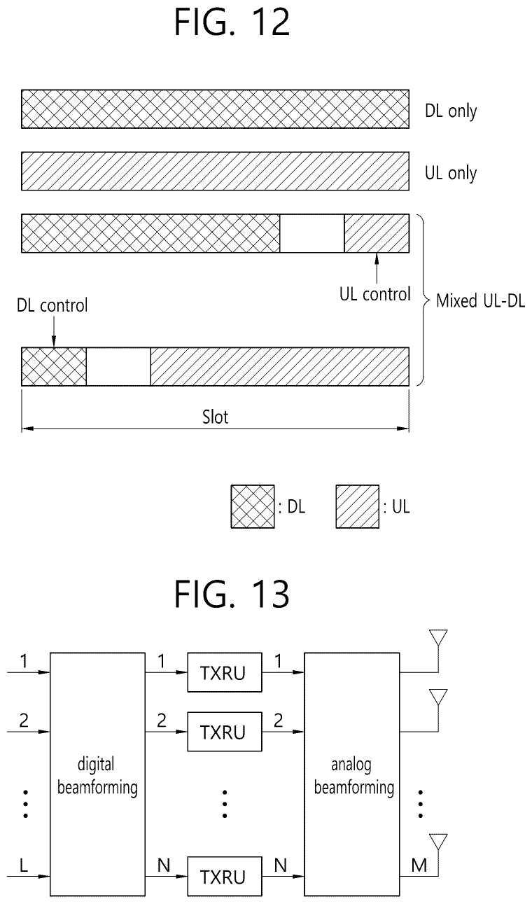

FIG. 12 illustrates a structure of a self-contained slot.

In an NR system, a DL control channel, DL or UL data, a UL control channel, and the like may be contained in one slot. For example, first N symbols (hereinafter, DL control region) in the slot may be used to transmit a DL control channel, and last M symbols (hereinafter, UL control region) in the slot may be used to transmit a UL control channel. N and M are integers greater than or equal to 0. A resource region (hereinafter, a data region) which exists between the DL control region and the UL control region may be used for DL data transmission or UL data transmission. For example, the following configuration may be considered. Respective durations are listed in a temporal order.
1. DL only configuration
2. UL only configuration
3. Mixed UL-DL configuration
   DL region+Guard period (GP)+UL control region
   DL control region+GP+UL region

DL region: (i) DL data region, (ii) DL control region+DL data region

UL region: (i) UL data region, (ii) UL data region+UL control region

A PDCCH may be transmitted in the DL control region, and a physical downlink shared channel (PDSCH) may be transmitted in the DL data region. A physical uplink control channel (PUCCH) may be transmitted in the UL control region, and a physical uplink shared channel (PUSCH) may be transmitted in the UL data region. Downlink control information (DCI), for example, DL data scheduling information, UL data scheduling information, and the like, may be transmitted on the PDCCH. Uplink control information (UCI), for example, ACK/NACK information about DL data, channel state information (CSI), and a scheduling request (SR), may be transmitted on the PUCCH. A GP provides a time gap in a process in which a BS and a UE switch from a TX mode to an RX mode or a process in which the BS and the UE switch from the RX mode to the TX mode. Some symbols at the time of switching from DL to UL within a subframe may be configured as the GP.

### <Analog Beamforming #1>

Wavelengths are shortened in millimeter wave (mmW) and thus a large number of antenna elements can be installed in the same area. That is, the wavelength is 1 cm at 30 GHz and thus a total of 100 antenna elements can be installed in the form of a 2-dimensional array at an interval of 0.5 lambda (wavelength) in a panel of 5×5 cm. Accordingly, it is possible to increase a beamforming (BF) gain using a large number of antenna elements to increase coverage or improve throughput in mmW.

In this case, if a transceiver unit (TXRU) is provided to adjust transmission power and phase per antenna element, independent beamforming per frequency resource can be performed. However, installation of TXRUs for all of about 100 antenna elements decreases effectiveness in terms of cost. Accordingly, a method of mapping a large number of antenna elements to one TXRU and controlling a beam direction using an analog phase shifter is considered. Such analog beamforming can form only one beam direction in all bands and thus cannot provide frequency selective beamforming.

Hybrid beamforming (BF) having a number B of TXRUs which is smaller than Q antenna elements can be considered as an intermediate form of digital BF and analog BF. In this case, the number of directions of beams which can be simultaneously transmitted are limited to B although it depends on a method of connecting the B TXRUs and the Q antenna elements.

### <Analog Beamforming #2>

When a plurality of antennas is used in NR, hybrid beamforming which is a combination of digital beamforming and analog beamforming is emerging. Here, in analog beamforming (or RF beamforming) an RF end performs precoding (or combining) and thus it is possible to achieve the performance similar to digital beamforming while reducing the number of RF chains and the number of D/A (or A/D) converters. For convenience, the hybrid beamforming structure may be represented by N TXRUs and M physical antennas. Then, the digital beamforming for the L data layers to be transmitted at the transmitting end may be represented by an N by L matrix, and the converted N digital signals are converted into analog signals via TXRUs, and analog beamforming represented by an M by N matrix is applied.

FIG. 13 is an abstract diagram of a hybrid beamforming structure from the viewpoint of the TXRU and the physical antenna.

In FIG. 13, the number of digital beams is L, and the number of analog beams is N. Furthermore, the NR system considers a direction supporting more efficient beamforming for a UE located in a specific area by designing a BS to change analog beamforming in units of symbols. Furthermore, the NR system considers even a method of introducing a plurality of antenna panels to which independent hybrid beamforming may be applied, when specific N TXRUs and M RF antennas are defined as one antenna panel in FIG. 13.

As described above, when a BS uses a plurality of analog beams, analog beams advantageous for signal reception may be different for each UE, and thus, regarding at least a synchronization signal, system information, paging, etc., a beam sweeping operation in which a plurality of analog beams to be applied by a BS in a specific subframe is changed for each symbol so that all Ues may have a reception opportunity is considered.

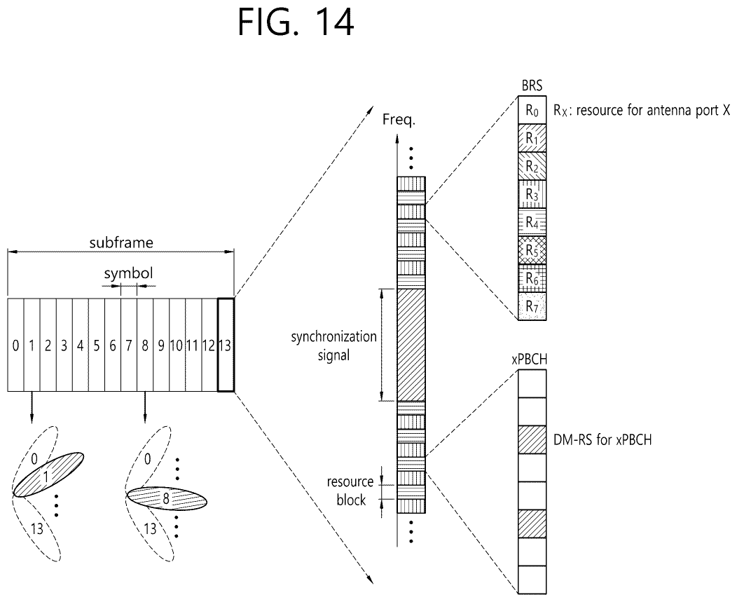

FIG. 14 is a diagram illustrating a beam sweeping operation for a synchronization signal and system information in a downlink (DL) transmission process.

In FIG. 14, a physical resource (or a physical channel) through which system information of an NR system is transmitted in a broadcasting manner is referred to as a physical broadcast channel (xPBCH). Here, analog beams belonging to different antenna panels within one symbol may be simultaneously transmitted, and in order to measure a channel for each analog beam, a method of introducing a beam reference signal (BRS), which is a reference signal (RS) to which a single analog beam (corresponding to a specific antenna panel) is applied and transmitted, as shown in FIG. 14, is under discussion. The BRS may be defined for a plurality of antenna ports, and each antenna port of the BRS may correspond to a single analog beam. In this case, unlike BRS, all analog beams of an analog beam group may be applied to a synchronization signal or xPBCH to transmit the synchronization signal or xPBCH so that any UE may properly receive the synchronization signal or xPBCH.

Now, the present disclosure will be described.

The present disclosure relates to a method for optimizing beam panel operation in a mobile UE supporting a multi-beam panel antenna.

In THz and millimeter wave (mmWave) environments, multi-beam panel technology can increase channel capacity and maximize the effects of increased bandwidth efficiency and increased throughput.

The present disclosure proposes a method for enabling seamless beam operation and capacity maximization by optimizing the utilization of multi-beam panels in a multi-beam panel environment of THz and millimeter frequencies.

By exchanging beam panel information such as beam bore sight information and beam scan angle range during the initialization process between the UE and the base station, the multi-beam panel position of the UE can be predicted. Additionally, by utilizing this, seamless beam-to-beam connection can be enabled and beam search time can be minimized when setting up additional beam links and in a beam handover environment between beam panels.

Previously, many technologies have been proposed to increase coverage by utilizing multi-beam panels and maximize channel efficiency by utilizing beam spatial multiplexing when operating THz or mmWave. In the conventional method, in order to achieve optimal beam tracking (i.e., to select the best beam), all beams for each beam panel should be checked, which increases overhead and takes a lot of time.

The tracking time for beam alignment depends on the number of beams and the number of beam panels. Therefore, it is necessary to deal with this when operating multi-beam panels. The beam search time delay and alignment limitations of existing multi-beam panels have limited the use of mmWave and have become factors that make service providers reluctant to invest in networks for mmWave band utilization. The expansion of THz beam operation, a key technology for 6G, may also be limited for the same reason.

The present disclosure simplifies additional beam link setup or inter TRP (transmit-receive point) beam handover process of a mobile UE during multi-beam panel operation by transmitting UE capability information including beam related information such as beam bore sight information and beam scan angle range to a system (e.g., during an initial UE access process), and minimizes delay time to enable resource-efficient, seamless multi-beam panel beam operation.

THz and millimeter frequencies have large path attenuation characteristics in the atmosphere due to their short wavelengths. To overcome this, technologies that utilize beams that exhibit large gain in a specific direction are being used. However, beams in the THz and millimeter ranges have small beam widths and limited beam scan angle ranges, so their usability is extremely limited when operating only with a single beam panel.

To overcome these shortcomings, a technology that enables beam reception at various directional angles by utilizing a multi-beam panel can be used. The multi-beam panel has great utility in the fields of MIMO and spatial beam multiplexing technology, distributed antennas, etc.

In order to operate a beam, a process of aligning the beam direction between the transmitter and receiver is required. To this end, beam direction and channel estimation are performed using a periodic sequence signal. In the standard specification, the SSB (Synchronization Signal Blocks) broadcast signal and the CSI-RS, which is a reference signal, are defined and operated within the frame for initial synchronization and beam selection and continuous tracking of the beam.

For UEs that provide mobility, the beam reselection process is performed without interruption by utilizing continuous tracking of the beam. To this end, the UE should periodically monitor SSB or CSI-RS signals to determine the optimal candidate beam and reselect the candidate beam as the serving beam, a repetitive process is essential.

In order to utilize the multi-beam panel, technologies that can actively select each beam panel and beam tracking technologies are important. Depending on how accurately and quickly this is done, the efficiency of the multi-beam panel operation and whether the beam channel can be operated at maximum capacity are determined.

In the conventional standard specifications, only a message procedure is defined to share only limited beam information of the UE with the network during the initial synchronization process and resource allocation process between the UE and the system. Through this process, the network determines the beam and antenna resource capacity and operating direction of the UE.

With only the limited beam information included in the above message in the prior art, the optimization of the operation of the multi-beam panel is bound to be limited, and the function of quickly tracking beams to multiple beam panels and reselecting beams also has further limitations in providing seamless services due to the limitation of the beam tracking time

In order to enable real-time use of AGV (Automated Guided Vehicle) UEs and UAM (Urban Air Mobility) technology in advanced smart factories in 5G and 6G environments, as well as ultra-immersive services such as AR/VR/XR and holograms, the operation and use of THz and millimeter wave multi-beam panels are expected to increase. To this end, by providing additional beam-related message information from the UE to the network (system), it is expected that faster and more accurate beam tracking and additional channel setting will be possible, and seamless smart convergence technology services will be possible.

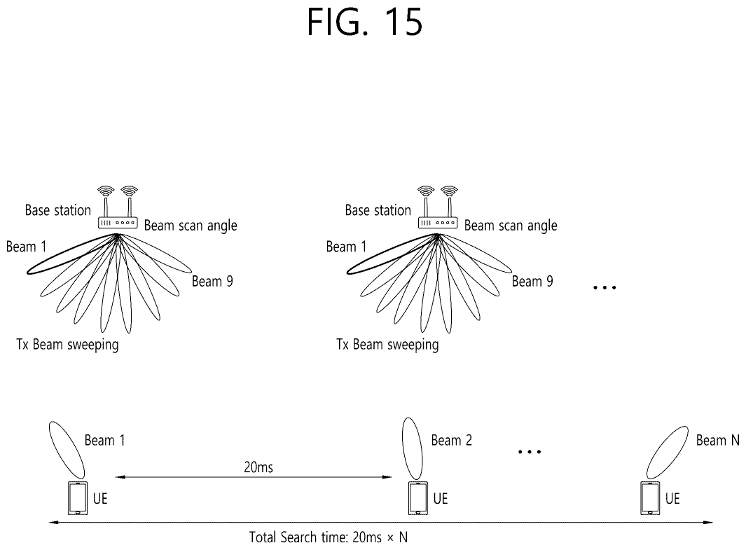

FIG. 15 is a diagram schematically illustrating a transmission beam sweeping process of a base station and a reception beam tracking process of a receiving UE for conventional beam search.

Referring to FIG. 15, the base station performs transmission beam sweeping using multiple beams, and performs this process periodically.

The UE changes the receiving beam at regular intervals (e.g., 20 ms) to find the best beam. If the number of receiving beams is N, for example, it may take up to 20 ms*N to find the best beam.

The UE can obtain initial synchronization and system resources through the initial cell search process and initial random access process through the beam search process with the base station.

The base station continuously transmits SSB signals in a broadcast manner by applying different beam indices. In order to find the best aligned beam using SSB signals repeated every 20 ms, the UE can find the beam with the largest RSRP (Reference Signal Received Power) signal by changing all beams in the reception beam list once.

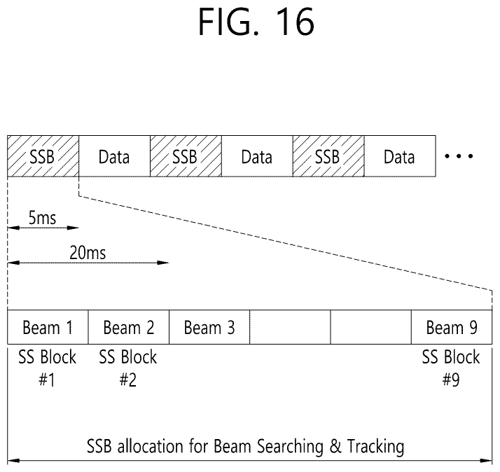

FIG. 16 shows an example of SSB resource allocation of a base station.

Referring to FIG. 16, in NR, a 5 ms SSB signal can be repeatedly transmitted at a 20 ms period. In a 5 ms SSB duration, multiple beams can be transmitted, and SSB can be transmitted for each beam. In this sense, SSB reflects the number of beams of a base station signal, and when many beams are operated, many SSB resources are used.

In addition, when operating many receive (RX) beams, longer initial beam search time and measurement time are required. The delay in beam search time is likely to cause problems such as link failure due to delay in setting up additional wireless channels and delay in beam reselection process when operating multi-beam panels. In addition, increased power consumption due to delay time can also be a problem.

Below, it is proposed a fast beam search method in a multi-beam panel environment.

### [NR UE Initial Access Process]

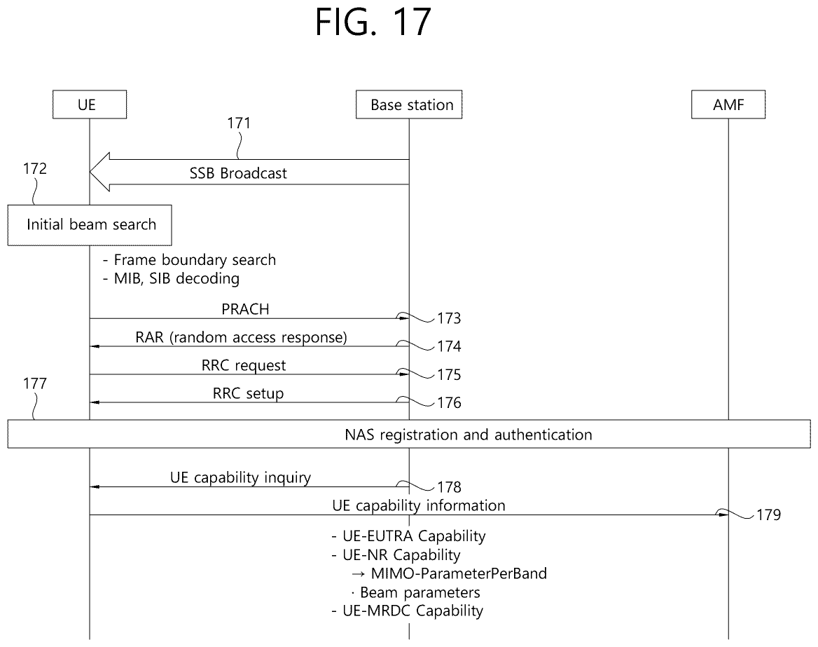

FIG. 17 illustrates an initial access procedure of a UE including a beam search process in NR.

Referring to FIG. 17, the UE performs an initial beam search process (172) to determine the initial best reception beam and beam panel by changing the reception beam based on an SSB signal (171) broadcast from a base station.

For example, frame boundary synchronization and MIB, SIB decoding can be performed in this process. Based on the information obtained through this, a preamble signal is transmitted to the base station through the PRACH (physical random access Channel) (173). After that, a state transition is made to the RRC setup (connection) state (176) through the random access response reception and RRC request process (174, 175).

Afterwards, after going through the NAS registration and authentication process (177) with the NR core (e.g., AMF), the UE transmits UE capability information in the form of three categories (179) to the core (AMF) in response to the UE capability information inquiry/request (178). At this time, the UE capability information may include beam related information. The beam related information may be included as an internal parameter of the “MIMO-ParameterPerBand” field, for example.

Below are examples of current beam-related capabilities.
1) beamCorrespondenceWithoutUL-BeamSweeping, 2) periodicBeamReport, 3) aperiodicBeamReport, 4) sp-BeamReportPUCCH, 5) sp-BeamReportPUSCH, 6) maxNumberRxBeam, 7) maxNumberRxTxBeamSwitchDL, 8) max NumberNonGroupBeamReporting, 9) groupBeamReporting, 10) uplinkBeamManangement, 11) beamReportTiming, 12) beamManagementSSB-CSI-RS, 13) beamSwitchTiming, 14) BeamManagementSSB-CSI-RS, 15) maxNumberPeriodicCSI-PerBWP-ForBeamReport, 16) maxNumberAperiodicCSI-PerBWP-ForBeamReport, 17) maxNumberSemiPersistentCSI-PerBWP-ForBeamReport.

The above beam-related capability items consist of beam reporting-related items and SSB and CSI-RS management items, and the current standard does not yet include beam related information for multi-beam panel operation.

### [Beam Failure and Beam Failure Recovery (BFR) in NR]

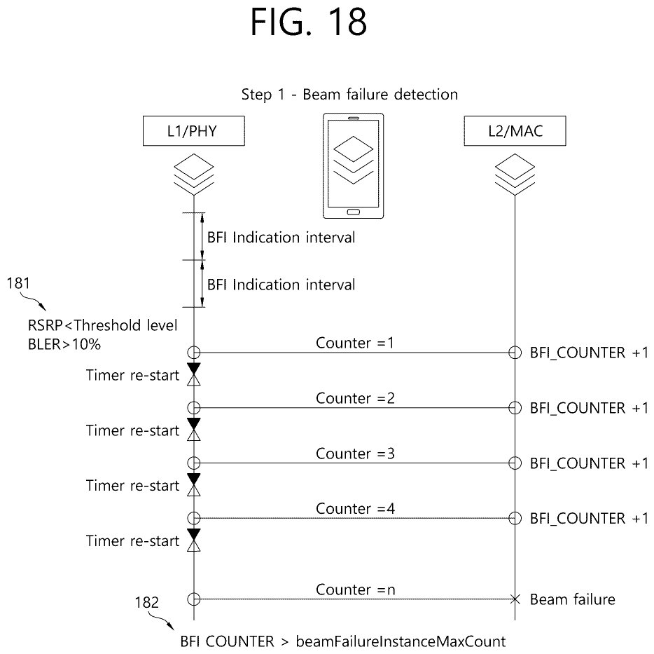

FIG. 18 illustrates a beam failure detection process between a UE and a base station in NR.

The L1/PHY layer of the UE compares the received RSRP with the RSRP threshold level (181).

The L1/PHY layer reports a beam failure indication (BFI) to the L2/MAC layer of the UE when the received RSRP is less than a threshold level value (and/or the BLER is greater than 10%).

Whenever a BFI is reported, the value of the BFI counter increases by 1, and when the BFI counter value becomes greater than the ‘beamFailureInstanceMaxCount’ value defined in the standard (182), i.e., when the received level value of RSRP is continuously less than the threshold level value, a beam failure occurrence is recognized.

Upon recognizing that a beam failure has occurred, the UE may perform a reference signal measurement or an initial beam search process to select the best beam. The time to find the best candidate beam may vary depending on the UE's received beam and the base station's SSB transmission period. For seamless/low power beam operation, multi-beam panels may require the application of techniques to minimize measurement time and power consumption.

Next, the UE performs a beam failure recovery process.

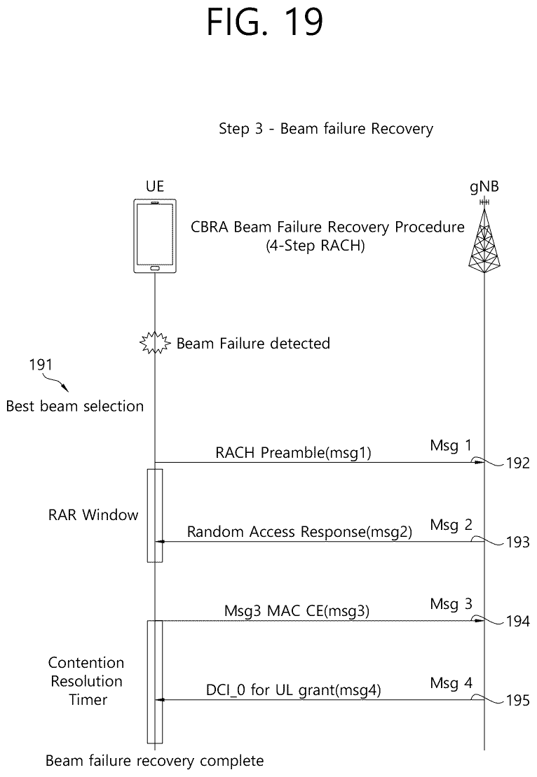

FIG. 19 illustrates a beam failure recovery process between a UE and a base station in NR.

A UE that recognizes a beam failure performs a process for selecting the best beam (191). For example, the UE performs a reference signal measurement or an initial beam search process.

The UE, after completing the selection of the best beam, performs a random access process to the base station. For example, the UE transmits a RACH preamble (message 1) to the base station (192) and receives a random access response (message 2) within the random access response (RAR) window (193). Afterwards, the UE transmits MAC CE (message 3) to the base station (194) and receives DCI (message 4, e.g., DCI_0 scheduling PUSCH) including UL grant within the time that the contention resolution timer operates (195). After this initial process, the beam failure recovery process is completed.

When a UE's serving beam fails, there is a time delay until the beam is restored, which may result in beam disconnection.

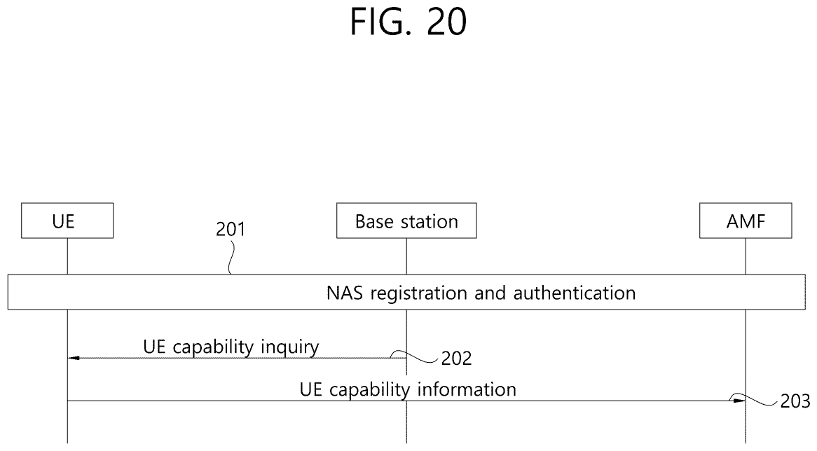

FIG. 20 illustrates a process of a UE responding to a request for UE capability information from a base station after an initial beam search. The process of FIG. 20 can be combined/added to the process of FIG. 17.

In FIG. 20, after the NAS registration and authentication process (201) with the NR core (AMF), in response to the base station's inquiry/request for UE capability information (202), the UE transmits UE capability information to the AMF (203). At this time, the UE capability information may include beam related information. The beam related information may include, for example, multi-beam panel and pattern information, beam panel-specific bore sight direction and angle information, and beam pattern information for each beam panel (e.g., beam scan range, HPBW, beam scan resolution, beam index, etc.). That is, beam related information related to the multi-beam panel is added to the existing UE capability information.

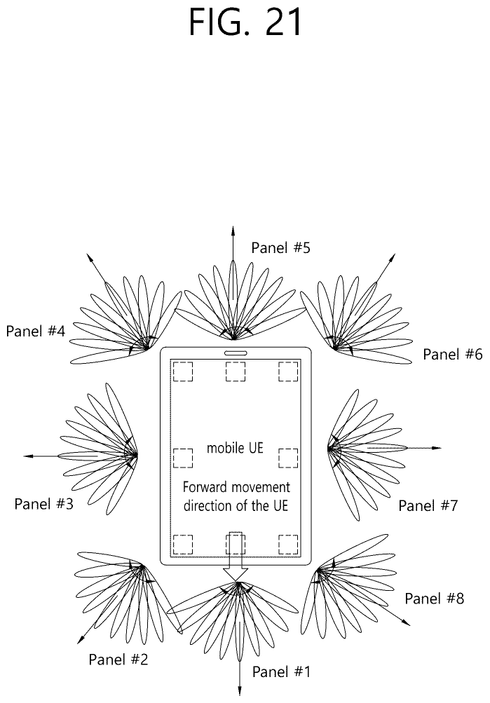

FIG. 21 illustrates a UE equipped with a beam panel for beam transmission and reception.

Referring to FIG. 21, beam panels (e.g., eight beam panels) for omnidirectional beam transmission and reception can be mounted on a mobile UE such as an AGV. Each beam panel can independently have operable beam pattern information (bore sight based on the forward movement direction of the UE, beam scan angle range, beam scan angle resolution, HPBW, beam index information, etc.). That is, beam related information is independently determined for each beam panel.

The above beam related information (beam pattern capability information) may include, for example, information as shown in the following table.

TABLE 4

| | Beam scan | | | | |
|---|---|---|---|---|---|
| Beam | range (beam | | | | |
| Panel | scan angle | | Beam scan | Bore sight | Beam |
| Index | range) | HPBW | resolution | angle | Index |
| 1 | 90 | 10 | 5 | 0 degrees | 0-17 |
| 2 | 120 | 10 | 5 | 30 degrees | 0-23 |
| 3 | 90 | 10 | 5 | 90 degrees | 0-17 |
| 4 | 120 | 10 | 5 | 120 degrees | 0-23 |
| 5 | 90 | 10 | 5 | 180 degrees | 0-17 |
| 6 | 120 | 10 | 5 | 210 degrees | 0-23 |
| 7 | 90 | 10 | 5 | 270 degrees | 0-17 |
| 8 | 120 | 10 | 5 | 300 degrees | 0-23 |

For a UE utilizing eight beam panels, beam related information (beam pattern capability information) of each beam panel can be configured as in the table above, and can be registered in the system through the TRP and/or baseband unit (base station) after the initial beam search.

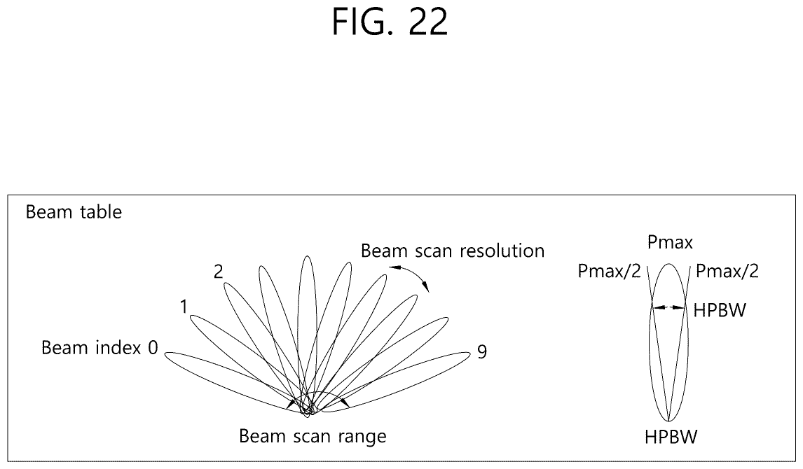

FIG. 22 illustrates beam related information.

Referring to FIG. 22, beam related information may include beam index for each beam, beam scan range, HPBW (Half Power Beam Width) of the beam, beam scan resolution (angle difference from adjacent beams) of each beam, etc. As described above, the beam related information may also be configured in the form of a table (e.g., Table 4).

[Method of operating a table and message transmission process according to the present disclosure: Method of adding a link by rapid additional beam search of a short-range multi-beam panel UE]

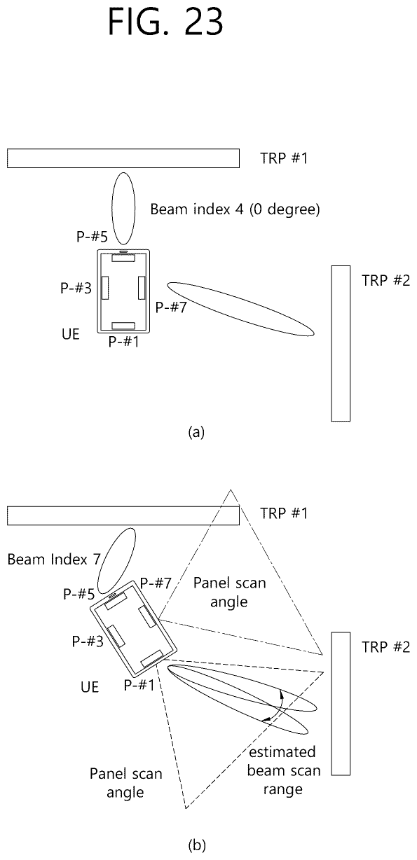

FIG. 23 illustrates the movement of a UE equipped with multi-beam panels in a short-range TRP environment.

The UE may be equipped with multiple beam panels (P-#1 to P-#8) (for convenience of explanation, only beam panels #1, 3, 5, and 7 are shown in the drawing). The UE may have a relative position with respect to TRP #1 and 2, as shown in (a) of FIG. 23. That is, a beam with beam index 4 in beam panel #5 (P-#5) can be used for TRP #1. The UE can report to the base station the current beam panel and beam index, beam panel #5 (P-#5), beam index 4, in relation to TRP #1.

Then, due to the movement of the UE, the UE can have a relative position with respect to TRP #1, 2 as in (b) of FIG. 23. That is, a beam with beam index 7 in beam panel #5 (P-#5) can be used for TRP #1. The UE can report beam panel #5 (P-#5), beam index 7 as the current beam panel and beam index in relation to TRP #1 to the base station.

Then, the base station can estimate the positional relationship of UEs, TRP #1 and 2, as in (b) of FIG. 23, based on beam related information, current beam panel, and beam index. Additionally, the base station can estimate, based on the beam related information, the current beam panel, and the beam index, that beam panel #7 (P-#7) is out of the reception range for TRP #2 and beam panel #1 (P-#1) is within the reception range for TRP #2 in a situation such as (b) of FIG. 23. Additionally, the base station can estimate a beam (e.g., beam index #4, 5) having an appropriate beam scan range in beam panel #1 (P-#1). The base station can provide this information, i.e., beam panel #1 (P-#1), beam index #4, 5, to the UE, and based on this information, the UE can perform the beam search process with TRP #2 by prioritizing beam indices #4 and 5 of beam panel #1 (P-#1).

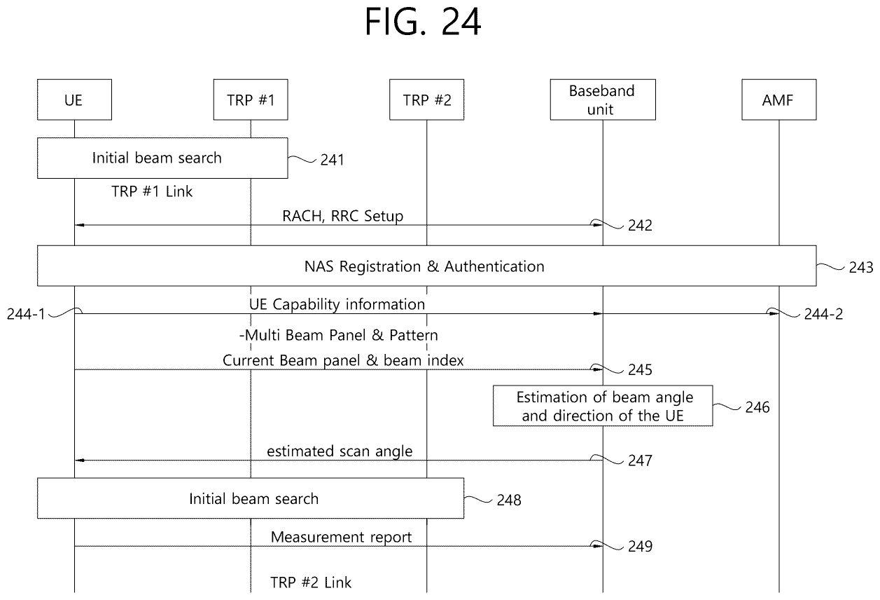

FIG. 24 illustrates a method for adding links by means of a fast additional beam search of a multi-beam panel UE. FIG. 24 can assume the positional relationship of the UEs, TRP #1, and 2 of FIG. 23.

Referring to FIG. 24, the UE performs an initial beam search in relation to TRP #1 (241). For example, upon initial access with TRP #1, the UE performs a beam search for each beam panel.

After that, the UE performs a RACH and RRC setup process (242) with a baseband unit (e.g., a base station). After that, the UE performs AMF and NAS registration and authentication procedures (243).

The UE provides UE capability information to the baseband unit (244-1). The baseband unit can transmit UE capability information to the AMF (244-2). UE capability information may include beam related information, such as information related to multi-beam panels and patterns.

The UE reports the current beam panel and beam index to the baseband unit (245). That is, after the UE completes selection of the best beam in relation to TRP #1, it can report the beam panel and beam index information to the base station.

The baseband unit estimates the beam angle and direction of the UE (246). For example, the base station can estimate the distance and direction of the UE based on the beam related information included in the UE capability information and the angle of the current beam indicated by the current beam (serving beam) index. Depending on the embodiment, the distance from TRP #1 can be estimated based on the RSSI (Received Signal Strength Indicator) or fingerprint of the received signal. Depending on the embodiment, more accurate positioning data operation is also possible using sensors, etc.

The baseband unit provides estimated information to the UE (247). The estimated information may include the base station's estimated beam panel number, estimated beam index information. For example, based on the UE capability information provided by the UE (more specifically, the beam related information contained in the UE capability information) and the UE's location, orientation, etc. estimated by the base station, the base station estimates the available beam panels (antenna panels) and candidate beam indices for the UE and provides the estimated information to the UE.

The UE performs an initial beam search in relation to TRP #2 (248). At this time, the UE performs the initial beam search with respect to TRP #2 using the beam panel and the candidate beam determined based on the above estimated information with priority.

After that, the UE performs a measurement report to the baseband unit (249). The measurement report may include panel information, beam index, RSRP, etc.

According to the present disclosure, a UE periodically reports to a base station initially found serving beam information and panel and beam index information (current beam panel information and beam index value) of a best beam obtained through CSI-RS or SSB measurement. At this time, the information may be transmitted by defining an additional parameter field in a CSI (Channel State Indication) report or by defining a new message.

Candidate beam panel/scan angle/beam index information for additional link formation obtained based on the result estimated by the baseband unit can be transmitted to the UE as estimated information through an RRC reconfiguration message, DCI information, or a new RRC message.

That is, the estimated information can be transmitted to the UE in one of the three ways below.
1) Transmission via RRC reconfiguration message, 2) Transmission via DCI, 3) Transmission by defining a new downlink message or new information parameters.

The UE performs a beam search in relation to TRP #2 using the determined beam panel and candidate beam based on the received estimated information (candidate panel information and beam index). For example, the UE can perform an initial beam search targeting TRP #2 using only the provided candidate panel information, beam index, and scan angle information.

That is, rather than performing a beam search using all beam panel information, the core uses the beam related information of the UE, the current beam panel information, and the current beam index information to estimate the available panel and beam index of the UE using a fast estimation technique, and transmits this to the UE to perform a beam search using this, thereby achieving fast beam additional operation, minimizing the beam search time of the multi-beam panel, and reducing power consumption accordingly.

### [Table Operation Method and Message Transmission Process of the Proposed Technology: Fast Beam Reselection and Handover Method of Long-Range Multi-Beam Panel UE]

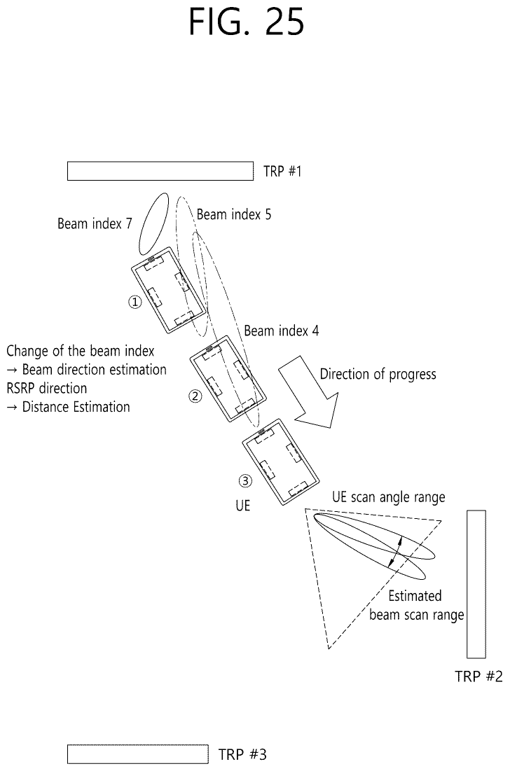

FIG. 25 illustrates the movement of a UE equipped with multi-beam panels in a long-range TRP environment. It is assumed that the UE of FIG. 25 is equipped with multi-beam panels identically to the UE of FIG. 23.

Referring to FIG. 25, the UE may be equipped with a plurality of beam panels (P-#1 to P-#8). The UE may move to positions 251, 252, and 253 in time.

At location 251, a beam with beam index 7 on beam panel #5 (P-#5) can be used for TRP #1. The UE can report to the base station the current beam panel and beam index, beam panel #5 (P-#5), beam index 7, in relation to TRP #1.

At position 252, a beam with beam index 5 on beam panel #5 (P-#5) can be used for TRP #1. The UE can report to the base station the current beam panel and beam index, beam panel #5 (P-#5), beam index 5, in relation to TRP #1.

At location 253, a beam with beam index 4 on beam panel #5 (P-#5) can be used for TRP #1. The UE can report to the base station the current beam panel and beam index, beam panel #5 (P-#5), beam index 4, in relation to TRP #1.

The base station can estimate the location/distance, directionality, etc. of the UE by using the location of the TRPs, the current beam panel and beam index reported by the UE, the RSRP of the received signal, and beam related information included in the UE capability information.

The base station can determine a handover from TRP #1 to TRP #2 located in the moving direction of the UE by using the estimated moving direction of the UE and the received signal level (e.g., RSRP).

The base station can provide the UE with estimated information necessary for the UE at position 253 to perform beam search in relation to TRP #2 based on beam related information, current beam panel and beam index.

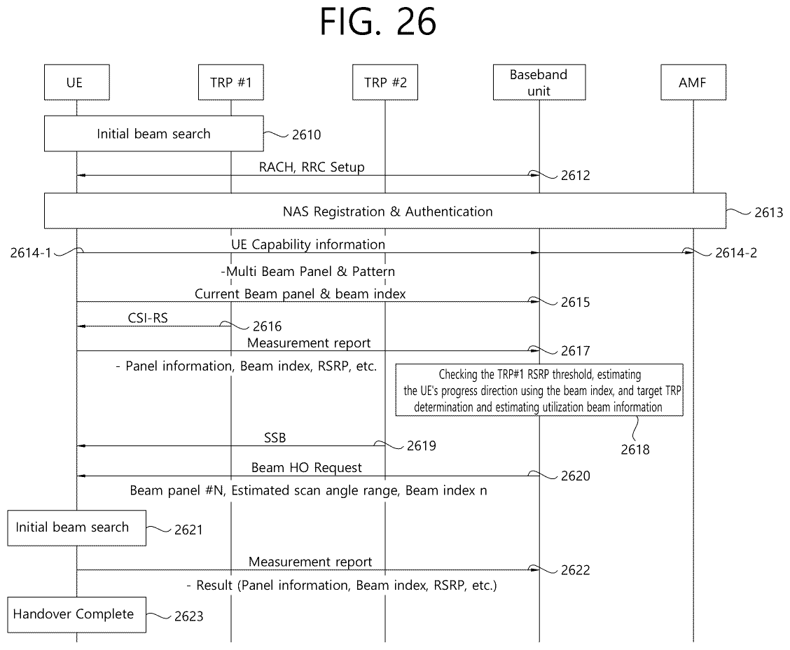

FIG. 26 illustrates a signaling process related to a process in which a UE equipped with multi-beam panels performs beam reselection (handover between TRPs) in a long-range TRP environment.

Referring to FIG. 26, the UE performs an initial beam search (2610) in the relationship with TRP #1. For example, upon initial access with TRP #1, the UE performs a beam search for each beam panel. The UE performs the process of RACH, and RRC set up with the baseband unit (e.g., base station) (2612). The UE then performs AMF and NAS registration and authentication procedures (2613).

The UE provides UE capability information to the baseband unit (2614-1). The baseband unit can transmit UE capability information to the AMF (2614-2). The UE capability information can include the beam related information described above.

The UE reports the current beam panel and beam index to the baseband unit (2615). That is, after the UE completes selection of the best beam, it can report the beam panel and beam index information to the base station.

TRP #1 transmits CSI-RS to the UE (2616). The UE reports the measurement result to the baseband unit (2617). The measurement result may include beam panel information, beam index information, RSRP, etc.

The baseband unit checks the TRP #1 RSRP threshold, estimates the UE's progress direction using the beam index, and estimates target TRP determination and utilization beam information (2618). When estimating the UE's position, progress direction, etc., the estimation can be based on, for example, the current beam panel and beam index information. In addition, the distance from TRP #1 can be estimated based on the RSSI (Received Signal Strength Indicator) or fingerprint of the received signal. At this time, more accurate positioning data operation is also possible by utilizing sensors, etc.

TRP #2 transmits SSB to the UE (2619). The baseband unit transmits a handover request to the UE (2620). In the handover request, beam panel index, estimated scan angle range, beam index information, etc. can be provided as estimated information. The estimated information can be delivered to the UE in one of the following three ways: 1) via an RRC reconfiguration message, 2) via DCI, or 3) by defining a new downlink message or new information parameters.

The UE performs an initial beam search based on the estimated information (2621). The UE reports the measurement results to the baseband unit (2622). The measurement results may include information such as panel information, beam index, RSRP, etc.

When the above process is completed, the UE completes the handover process (2623).

In the long-range operation of a highly mobile UE, beam operation for accurate beamforming is important, but handover between beams to minimize link failure of beams due to movement, i.e., seamless beam switching or reselection process, is also an important system requirement. According to the disclosed method, seamless handover between panels and beams is possible in a mobile UE situation, and the message transmission process for this is described.

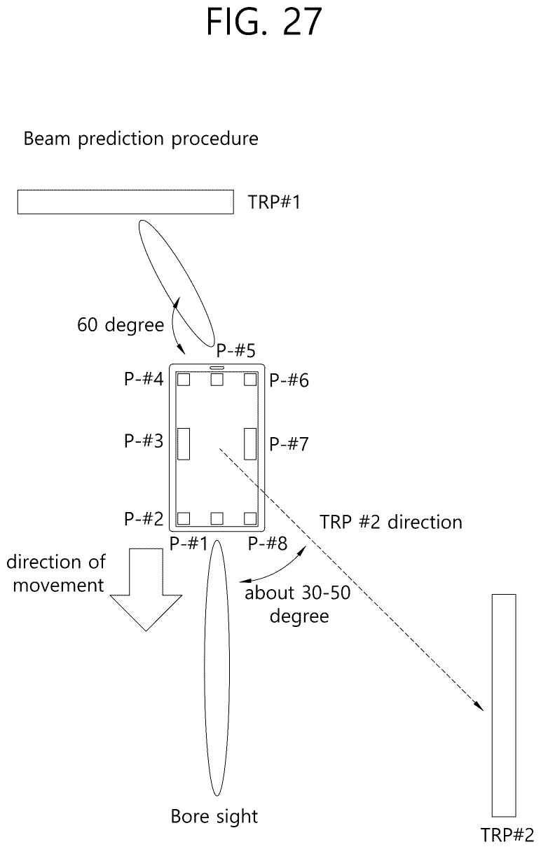

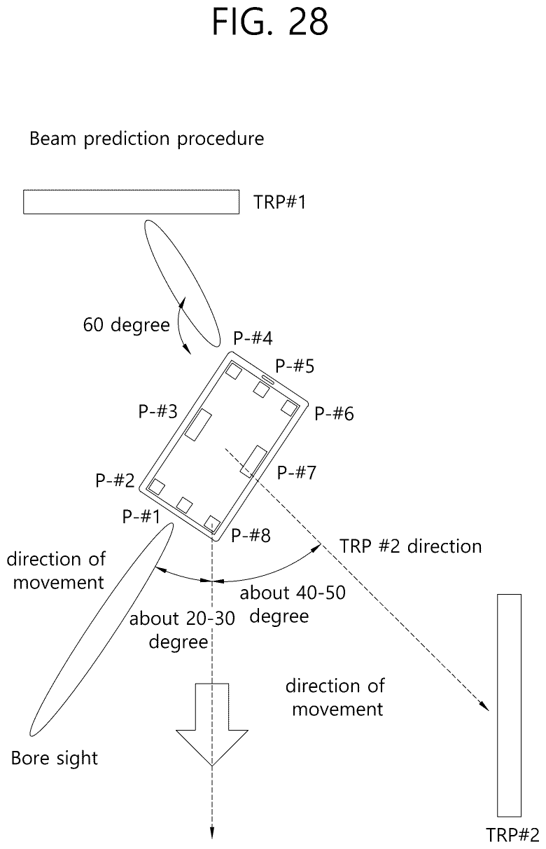

FIGS. 27 and 28 illustrate beam prediction processes.

Referring to FIG. 27, the UE includes eight antenna panels. The current beam has an angle of 60 degrees with TRP #1, and panel #5 is used.

A rough estimate of the angle between the front of the UE and the direction of movement is 0 degrees (A). A rough estimate of the angle between the position of the target (TRP #2) and the current position of the UE is 30 to 50 degrees (B).

The base station estimates the candidate beam panel and beam index, which is 310 to 330 degrees by subtracting B and A from 360 degrees. When the base station selects a beam panel of the corresponding beam range (or closest to the corresponding beam range) from a table related to beam related information, panel #8 may be selected. The candidate beam index may be selected by considering the bore sight angle.

Referring to FIG. 28, the UE includes eight antenna panels. The current beam has an angle of 60 degrees with TRP #1, and panel #4 is used.

A rough estimate of the angle between the front of the UE and the direction of movement is 20 to 30 degrees (A). A rough estimate of the angle between the position of the target (TRP #2) and the current position of the UE is 40 to 50 degrees (B). If 360 degrees is subtracted from B and A above, it is 280 to 300 degrees. Considering this situation, the base station can estimate the candidate beam panel and beam index. If the base station selects a beam panel in its beam range (or closest to its beam range) from the table associated with the beam related information, panel #7 or 8 may be selected. The candidate beam index may be selected by considering the bore sight angle.

It is assumed that the error in direction estimation can be as large as the beam scan resolution. As the scan resolution of the beam decreases, more precise prediction of the direction of movement becomes possible.

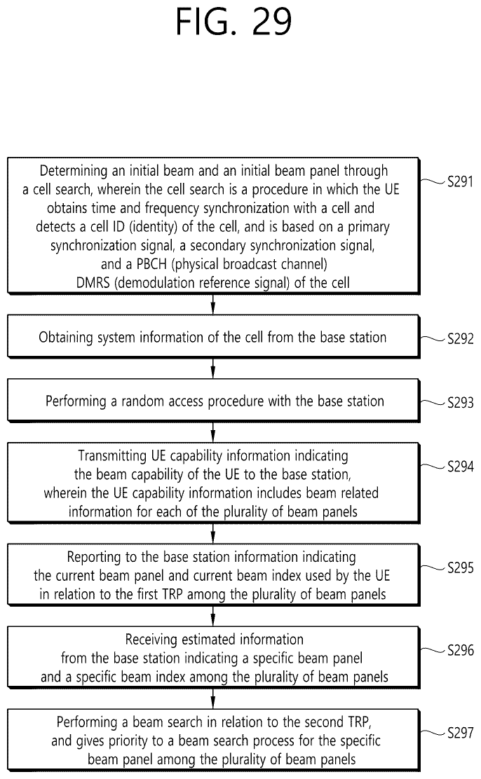

FIG. 29 illustrates an operation method of a UE including a plurality of beam panels in a wireless communication system according to the present disclosure.

Referring to FIG. 29, a UE determines an initial beam (initial best reception beam) and an initial beam panel through a cell search, wherein the cell search is a procedure in which the UE obtains time and frequency synchronization with a cell and detects a cell ID (identity) of the cell, and is based on a primary synchronization signal, a secondary synchronization signal, and a PBCH (physical broadcast channel) DMRS (demodulation reference signal) of the cell (S291).

The UE obtains system information of the cell from the base station (S292). The base station may be a wireless device that controls multiple TRPs. For example, the base station may control a first TRP (transmit-receive point) and a second TRP.

The UE performs a random access procedure with the base station (S293). The random access procedure may include, for example, i) a step of the UE transmitting a random access preamble to the base station, ii) a step of receiving a random access response from the base station, iii) a step of performing scheduled transmission using a scheduled uplink grant in the random access response, and iv) a step of receiving a contention resolution message.

The UE transmits UE capability information (the UE capability information may be configured in the form of a beam capability table, for example) indicating the beam capability of the UE itself to the base station (S294). The UE capability information (beam capability table) includes beam related information for each of the plurality of beam panels.

The beam related information may include, for example, at least one of i) beam scan range, ii) half power beam width (HPBW) of the beam, iii) beam scan resolution, iv) bore sight angle of the beam, and v) beam index for each beam panel.

Beam related information can be configured in a form such as Table 4 described above, for example.

The UE reports to the base station information indicating the current beam panel and current beam index used by the UE in relation to the first TRP among the plurality of beam panels (S295).

Information indicating the current beam panel and the current beam index may be reported periodically to the base station, and may be reported by defining an additional parameter field in a CSI (channel state information) report, or may be reported through a new message defined for reporting the current beam panel and the current beam index.

Thereafter, the UE receives estimated information from the base station indicating a specific beam panel and a specific beam index among the plurality of beam panels (S296). Here, the specific beam panel and the specific beam index may be a beam panel and a beam estimated by the base station to be applied to the UE in the future in the relationship between the UE and the second TRP based on the UE capability information, the current beam panel and the current beam index. The specific method thereof has been described in FIGS. 23, 25, 27, and 28.

The base station may provide the UE with the estimated information indicating the specific beam panel and the specific beam index by including it in, for example, an RRC (radio resource control) message (RRC reconfiguration message) or DCI (downlink control information). Alternatively, a new message may be defined to indicate the specific beam panel and the specific beam index, and the specific beam panel and the specific beam index may be indicated through the new message.

The UE performs a beam search in relation to the second TRP, and gives priority to a beam search process for the specific beam panel among the plurality of beam panels (S297).

According to the present disclosure, a UE can perform a beam search using a specific beam panel and a specific beam index provided by a base station (core), rather than a beam search using all panel information, for example, in relation to TRP #2. As described above, the specific beam panel and the specific beam index are estimated by using the UE capability information, the current beam panel, and the current beam index information to estimate the available panel and beam index of the UE using a fast estimation technique. According to this method, fast beam operation and minimization of the beam search time of the multi-beam panel are possible, and power consumption can also be reduced.

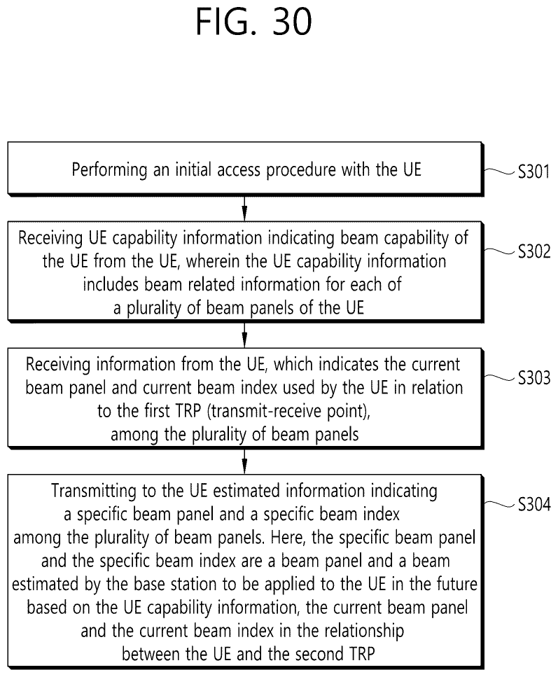

FIG. 30 illustrates a method performed by a base station in a wireless communication system according to one embodiment of the present disclosure.

Referring to FIG. 30, the base station performs an initial access procedure with the UE (S301).

The base station receives UE capability information indicating beam capability of the UE from the UE, wherein the UE capability information includes beam related information for each of a plurality of beam panels of the UE (S302).

As described above, the UE capability information may be configured in the form of, for example, a beam capability table.

The base station receives information from the UE, which indicates the current beam panel and current beam index used by the UE in relation to the first TRP (transmit-receive point), among the plurality of beam panels (S303).

The base station transmits to the UE estimated information indicating a specific beam panel and a specific beam index among the plurality of beam panels (S304). Here, the specific beam panel and the specific beam index are a beam panel and a beam estimated by the base station to be applied to the UE in the future based on the UE capability information, the current beam panel and the current beam index in the relationship between the UE and the second TRP.

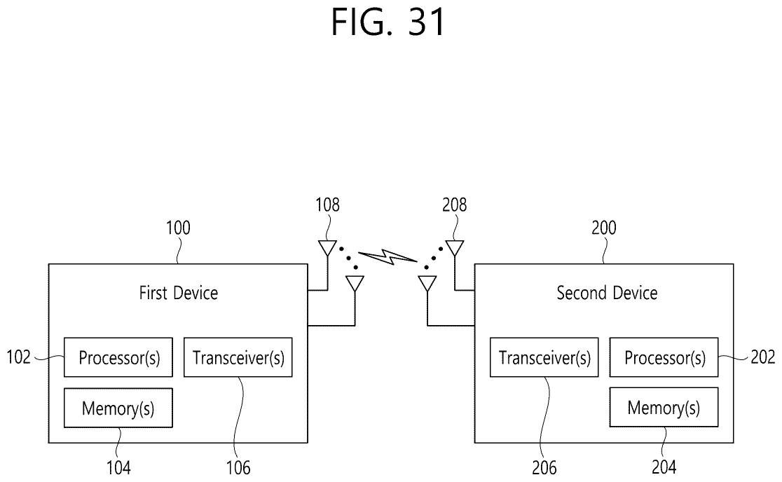

FIG. 31 illustrates a wireless device applicable to the present disclosure.

Referring to FIG. 31, a first wireless device 100 and a second wireless device 200 may transmit radio signals through a variety of RATs (e.g., LTE and NR).

The first wireless device 100 may include one or more processors 102 and one or more memories 104 and additionally further include one or more transceivers 106 and/or one or more antennas 108. The processors 102 may control the memory 104 and/or the transceivers 106 and may be configured to implement the descriptions, functions, procedures, proposals, methods, and/or operational flowcharts disclosed in this document. For example, the processors 102 may process information within the memory 104 to generate first information/signals and then transmit radio signals including the first information/signals through the transceivers 106. In addition, the processor 102 may receive radio signals including second information/signals through the transceiver 106 and then store information obtained by processing the second information/signals in the memory 104. The memory 104 may be connected to the processory 102 and may store a variety of information related to operations of the processor 102. For example, the memory 104 may store software code including commands for performing a part or the entirety of processes controlled by the processor 102 or for performing the descriptions, functions, procedures, proposals, methods, and/or operational flowcharts disclosed in this document. Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. The transceiver 106 may include a transmitter and/or a receiver. The transceiver 106 may be interchangeably used with a radio frequency (RF) unit. In the present specification, the wireless device may represent a communication modem/circuit/chip.

The first wireless device 100 may be a UE. The UE determines an initial beam and an initial beam panel through a cell search, the cell search being a procedure wherein the UE obtains time and frequency synchronization with a cell and detects a cell identity of the cell, based on a primary synchronization signal, a secondary synchronization signal and a physical broadcast channel (PBCH) demodulation reference signal (DMRS) of the cell. The UE obtains system information of the cell from a base station, performs a random access procedure with the base station, wherein the random access procedure comprises: i) transmitting, by the UE, a random access preamble to the base station; ii) receiving a random access response from the base station, iii) performing a scheduled transmission using the scheduled uplink grant in the random access response; and iv) receiving a contention resolution message. The UE transmits to the base station UE capability information for beam capability of the UE, wherein the UE capability information comprises beam related information for each of the plurality of beam panels, reports to the base station information for a current beam panel among the plurality of beam panels and a current beam index used by the UE in relation to a first transmit-receive point (TRP), receives from the base station estimated information for a specific beam panel among the plurality of beam panels and a specific beam index, and performs a beam search in relation to a second TRP, wherein a beam search procedure for the specific beam panel among the plurality of beam panels is performed with priority.

The second wireless device 200 may include one or more processors 202 and one or more memories 204 and additionally further include one or more transceivers 206 and/or one or more antennas 208. The processor 202 may control the memory 204 and/or the transceiver 206 and may be configured to implement the descriptions, functions, procedures, proposals, methods, and/or operational flowcharts disclosed in this document. For example, the processor 202 may process information within the memory 204 to generate third information/signals and then transmit radio signals including the third information/signals through the transceiver 206. In addition, the processor 202 may receive radio signals including fourth information/signals through the transceiver 106 and then store information obtained by processing the fourth information/signals in the memory 204. The memory 204 may be connected to the processor 202 and may store a variety of information related to operations of the processor 202. For example, the memory 204 may store software code including commands for performing a part or the entirety of processes controlled by the processor 202 or for performing the descriptions, functions, procedures, proposals, methods, and/or operational flowcharts disclosed in this document. Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. The transceiver 206 may include a transmitter and/or a receiver. The transceiver 206 may be interchangeably used with an RF unit. In the present specification, the wireless device may represent a communication modem/circuit/chip.

The second wireless device 200 may be a base station described above. The base station performs an initial access procedure with a user equipment (UE), receives, from the UE, UE capability information for a beam capability of the UE, wherein the UE capability information includes beam related information for each of a plurality of beam panels of the UE, receives, from the UE, information for a current beam panel among the plurality of beam panels and a current beam index used by the UE in relation to a first transmit-receive point (TRP), and transmits, to the UE, estimated information for a specific beam panel among the plurality of beam panels and a specific beam index. Here, the specific beam panel and the specific beam index are a beam panel and a beam to be applied to the UE in the future, estimated by the base station based on the UE capability information, the current beam panel and the current beam index, in the relationship between the UE and the second TRP.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. For example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. In addition, the one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. In addition, the one or more processors 102 and 202 may perform control so that the one or more transceivers 106 and 206 may receive user data, control information, or radio signals from one or more other devices. In addition, the one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

In FIG. 31, the case where the processor and memory are configured separately is exemplified, but this is not a limitation. That is, the processor and memory may be combined into one device (i.e., one chipset).

Hereinafter, an example of a structure of a signal processing module of a transmitter to which the present disclosure is applied will be described.

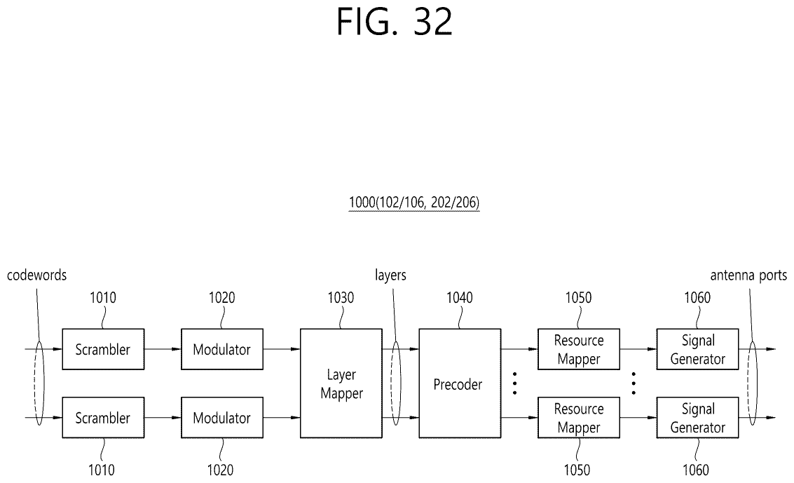

FIG. 32 is an example of a structure of a signal processing module of a transmitter.

Referring to FIG. 32, a signal processing circuit 1000 may include a scrambler 1010, a modulator 1020, a layer mapper 1030, a precoder 1040, a resource mapper 1050, and a signal generator 1060. Although not limited thereto, the operations/functions of FIG. 32 may be performed in the processors 102 and 202 and/or the transceivers 106 and 206 of FIG. 31. The hardware elements of FIG. 32 may be implemented in the processors 102 and 202 and/or the transceivers 106 and 206 of FIG. 31. For example, blocks 1010 to 1060 may be implemented in the processors 102 and 202 of FIG. 31. Further, blocks 1010 to 1050 may be implemented in the processors 102 and 202 of FIG. 31, and block 1060 may be implemented in the transceivers 106 and 206 of FIG. 31.

A codeword may be converted into a wireless signal through the signal processing circuit 1000 of FIG. 32. Here, the codeword is an encoded bit sequence of an information block. The information block may include a transport block (e.g., a UL-SCH transport block or a DL-SCH transport block). A wireless signal may be transmitted through various physical channels (e.g., PUSCH or PDSCH).

Specifically, the codeword may be converted into a bit sequence scrambled by the scrambler 1010. A scrambled sequence used for scramble may be generated based on an initialization value, and the initialization value may include ID information of a wireless device. The scrambled bit sequence may be modulated into a modulation symbol sequence by the modulator 1020. A modulation scheme may include pi/2-binary phase shift keying (pi/2-BPSK), m-phase shift keying (m-PSK), m-quadrature amplitude modulation (m-QAM), and the like. A complex modulation symbol sequence may be mapped to one or more transport layers by the layer mapper 1030. Modulation symbols of each transport layer may be mapped to corresponding antenna port(s) by the precoder 1040 (precoding). An output z of the precoder 1040 may be obtained by multiplying an output y of the layer mapper 1030 by an N*M precoding matrix W. Here, N is the number of antenna ports, and M is the number of transport layers. Here, the precoder 1040 may perform precoding after performing transform precoding (e.g., DFT transform) on complex modulation symbols. Also, the precoder 1040 may perform precoding without performing transform precoding.

The resource mapper 1050 may map modulation symbols of each antenna port to a time-frequency resource. A time-frequency resource may include a plurality of symbols (e.g., CP-OFDMA symbols or DFT-s-OFDMA symbols) in a time domain and may include a plurality of subcarriers in a frequency domain. The signal generator 1060 may generate a wireless signal from the mapped modulation symbols, and the generated wireless signal may be transmitted to another device through each antenna. To this end, the signal generator 1060 may include an inverse fast Fourier transform (IFFT) module, a cyclic prefix (CP) inserter, a digital-to-analog converter (DAC), a frequency uplink converter, and the like.

A Signal processing process for a received signal in a wireless device may be configured as the reverse of the signal processing process 1010 to 1060 of FIG. 32. For example, a wireless device (e.g., 100 and 200 in FIG. 31) may receive a wireless signal from the outside through an antenna port/transceiver. The received wireless signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be reconstructed into a codeword through a resource de-mapper process, a postcoding process, a demodulation process, and a de-scramble process. The codeword may be restored to an original information block through decoding. Accordingly, a signal processing circuit (not shown) for a received signal may include a signal restorer, a resource demapper, a postcoder, a demodulator, a descrambler, and a decoder.

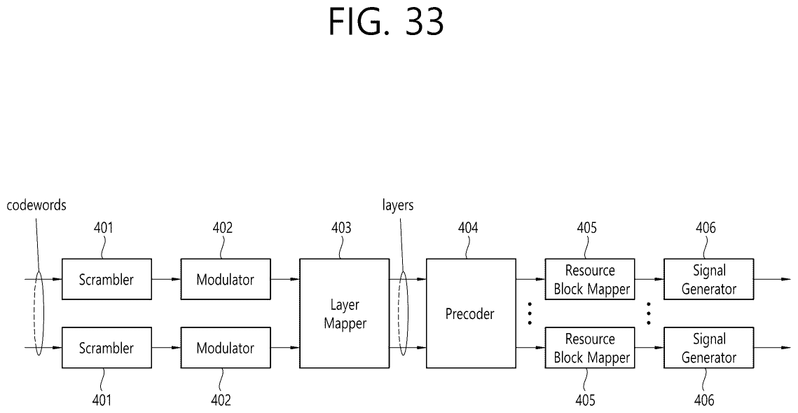

FIG. 33 shows another example of a structure of a signal processing module in a transmission device. Here, signal processing may be performed by a processor of a UE/BS such as the processors 102 and 202 of FIG. 31.

Referring to FIG. 33, a transmission device (e.g., 102, 202, 106, or 206) in a UE or a BS may include a scrambler 401, a modulator 402, a layer mapper 403, a precoder 404, a resource block mapper 405, and a signal generator 406.

The transmitting device can scramble coded bits in a codeword by the corresponding scrambler 401 and then transmit the scrambled coded bits through a physical channel.

Scrambled bits are modulated into complex-valued modulation symbols by the corresponding modulator 402. The modulator can modulate the scrambled bits according to a predetermined modulation scheme to arrange complex-valued modulation symbols representing positions on a signal constellation. The modulation scheme is not limited and pi/2-BPSK (pi/2-Binary Phase Shift Keying), m-PSK (m-Phase Shift Keying) or m-QAM (m-Quadrature Amplitude Modulation) may be used to modulate the coded data.

The complex-valued modulation symbols can be mapped to one or more transport layers by the layer mapper 403.

Complex-valued modulation symbols on each layer can be precoded by the precoder 404 for transmission on an antenna port. Here, the precoder may perform transform precoding on the complex-valued modulation symbols and then perform precoding. Alternatively, the precoder may perform precoding without performing transform precoding. The precoder 404 can process the complex-valued modulation symbols according to MIMO using multiple transmission antennas to output antenna-specific symbols and distribute the antenna-specific symbols to the corresponding resource block mapper 405. An output z of the precoder 404 can be obtained by multiplying an output y of the layer mapper 403 by an N×M precoding matrix W. Here, N is the number of antenna ports and M is the number of layers.

Each resource block mapper 405 maps complex-valued modulation symbols with respect to each antenna port to appropriate resource elements in a virtual resource block allocated for transmission.

The resource block mapper 405 can allocate complex-valued modulation symbols to appropriate subcarriers and multiplex the complex-valued modulation symbols according to a user.

Signal generator 406 can modulate complex-valued modulation symbols according to a specific modulation scheme, for example, OFDM, to generate a complex-valued time domain OFDM symbol signal. The signal generator 406 can perform IFFT (Inverse Fast Fourier Transform) on antenna-specific symbols, and a CP (cyclic Prefix) can be inserted into time domain symbols on which IFFT has been performed. OFDM symbols are subjected to digital-analog conversion and frequency up-conversion and then transmitted to the receiving device through each transmission antenna. The signal generator 406 may include an IFFT module, a CP inserting unit, a digital-to-analog converter (DAC) and a frequency upconverter.

The signal processing procedure of the receiving device may be reverse to the signal processing procedure of the transmitting device. Specifically, the processor of the transmitting device decodes and demodulates RF signals received through antenna ports of the transceiver. The receiving device may include a plurality of reception antennas, and signals received through the reception antennas are restored to baseband signals, and then multiplexed and demodulated according to MIMO to be restored to a data string intended to be transmitted by the transmitting device. The receiving device may include a signal restoration unit that restores received signals to baseband signals, a multiplexer for combining and multiplexing received signals, and a channel demodulator for demodulating multiplexed signal strings into corresponding codewords. The signal restoration unit, the multiplexer and the channel demodulator may be configured as an integrated module or independent modules for executing functions thereof. More specifically, the signal restoration unit may include an analog-to-digital converter (ADC) for converting an analog signal into a digital signal, a CP removal unit that removes a CP from the digital signal, an FET module for applying FFT (fast Fourier transform) to the signal from which the CP has been removed to output frequency domain symbols, and a resource element demapper/equalizer for restoring the frequency domain symbols to antenna-specific symbols. The antenna-specific symbols are restored to transport layers by the multiplexer and the transport layers are restored by the channel demodulator to codewords intended to be transmitted by the transmitting device.

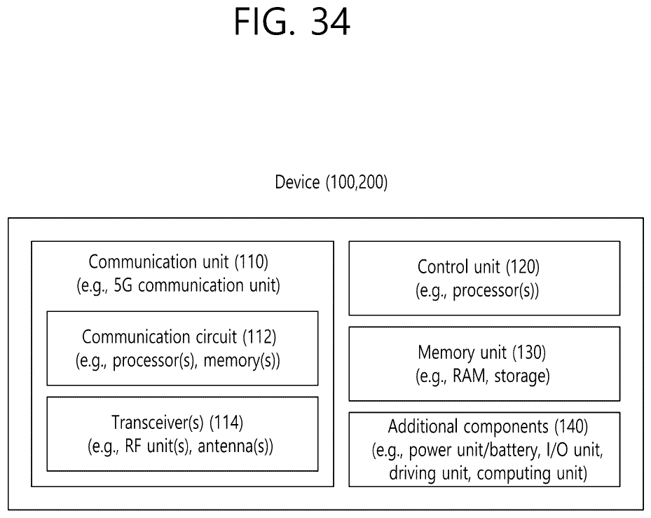

FIG. 34 shows another example of a wireless device applied to the present disclosure. The wireless device may be implemented in various forms according to use-examples/services.

Referring to FIG. 34, wireless devices 100 and 200 may correspond to the wireless devices 100 and 200 of FIG. 31 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 31. For example, the transceiver(s) 114 may include the one or more transceivers 106 and 206 and/or the one or more antennas 108 and 208 of FIG. 31. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. In addition, the control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

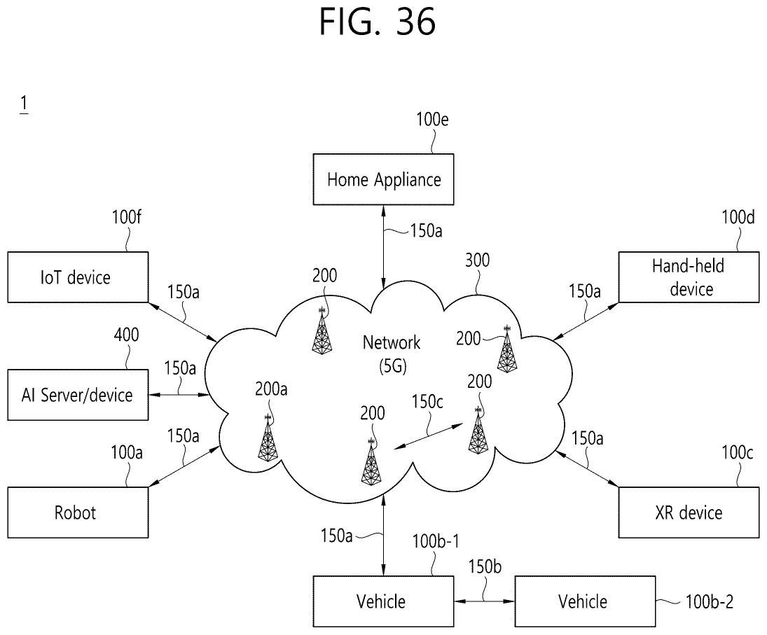

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 36), the vehicles (100b-1 and 100b-2 of FIG. 36), the XR device (100c of FIG. 36), the hand-held device (100d of FIG. 36), the home appliance (100e of FIG. 36), the IoT device (100f of FIG. 36), a digital broadcast UE, a hologram device, a public safety device, an MTC device, a medicine device, a fintech device (or a finance device), a security device, a climate/environment device, the AI server/device (400 of FIG. 36), the BSs (200 of FIG. 36), a network node, etc. The wireless device may be used in a mobile or fixed place according to a use-example/service.

In FIG. 31, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. In addition, each element, component, unit/portion, and/or module within the wireless devices 100 and 200 may further include one or more elements. For example, the control unit 120 may be configured by a set of one or more processors. For example, the control unit 120 may be configured by a set of a communication control processor, an application processor, an Electronic Control Unit (ECU), a graphical processing unit, and a memory control processor. For another example, the memory 130 may be configured by a Random Access Memory (RAM), a Dynamic RAM (DRAM), a Read Only Memory (ROM)), a flash memory, a volatile memory, a non-volatile memory, and/or a combination thereof.

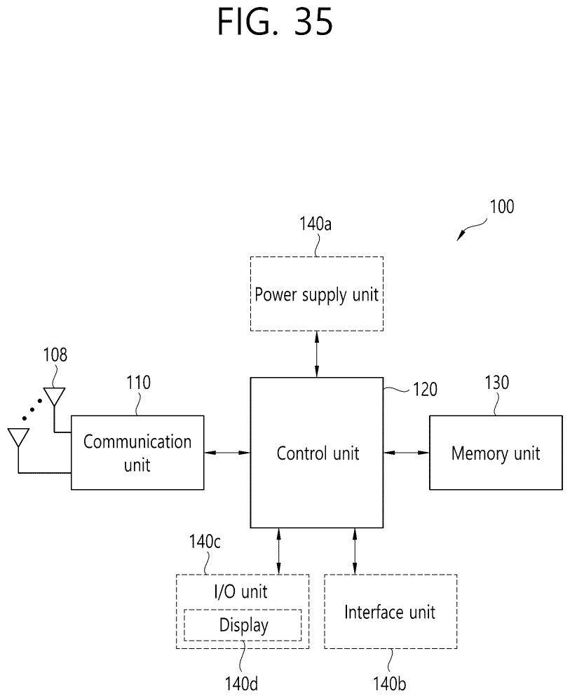

FIG. 35 illustrates a hand-held device applied to the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT).

Referring to FIG. 35, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c respective correspond to the blocks 110 to 130/140 of FIG. 33.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. In addition, the memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

For example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. In addition, the communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

Additionally, the methods described herein can be realized by a computer-readable communication medium that carries or communicates code, at least in part, in the form of instructions or data structures, and that a computer can access, read, and/or execute.

According to some implementations of this specification, a non-transitory computer-readable medium (CRM) stores a plurality of instructions.

More specifically, a CRM stores instructions that cause operations to be performed by one or more processors. The operations comprise determining an initial beam and an initial beam panel through a cell search, the cell search being a procedure wherein the UE obtains time and frequency synchronization with a cell and detects a cell identity of the cell, based on a primary synchronization signal, a secondary synchronization signal and a physical broadcast channel (PBCH) demodulation reference signal (DMRS) of the cell, obtaining system information of the cell from a base station, performing a random access procedure with the base station, wherein the random access procedure comprises: i) transmitting, by the UE, a random access preamble to the base station; ii) receiving a random access response from the base station, iii) performing a scheduled transmission using the scheduled uplink grant in the random access response; and iv) receiving a contention resolution message, transmitting to the base station UE capability information for beam capability of the UE, wherein the UE capability information comprises beam related information for each of the plurality of beam panels, reporting to the base station information for a current beam panel among the plurality of beam panels and a current beam index used by the UE in relation to a first transmit-receive point (TRP), receiving from the base station estimated information for a specific beam panel among the plurality of beam panels and a specific beam index, and performing a beam search in relation to a second TRP, wherein a beam search procedure for the specific beam panel among the plurality of beam panels is performed with priority.

FIG. 36 illustrates a communication system 1 applied to the present disclosure.

Referring to FIG. 36, a communication system 1 applied to the present specification includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). In addition, the IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

Meanwhile, the NR supports multiple numerologies (or subcarrier spacing (SCS)) for supporting diverse 5G services. For example, if the SCS is 15 kHz, a wide area of the conventional cellular bands may be supported. If the SCS is 30 kHz/60 kHz, a dense-urban, lower latency, and wider carrier bandwidth is supported. If the SCS is 60 kHz or higher, a bandwidth greater than 24.25 GHz is used in order to overcome phase noise.

An NR frequency band may be defined as a frequency range of two types (FR1, FR2). Values of the frequency range may be changed. For example, the frequency range of the two types (FR1, FR2) may be as shown below in Table 5. For convenience of explanation, among the frequency ranges that are used in an NR system, FR1 may mean a “sub 6 GHz range”, and FR2 may mean an “above 6 GHz range” and may also be referred to as a millimeter wave (mmW).

TABLE 5

| Frequency Range | Corresponding frequency | Subcarrier Spacing |
|---|---|---|
| designation | range | (SCS) |
| FR1 | 450 MHz-6000 MHz | 15, 30, 60 kHz |
| FR2 | 24250 MHz-52600 MHz | 60, 120, 240 kHz |

As described above, the values of the frequency ranges in the NR system may be changed. For example, as shown in Table 6 below, FR1 may include a band in the range of 410 MHz to 7125 MHz. That is, FR1 may include a frequency band of at least 6 GHz (or 5850, 5900, 5925 MHz, and so on). For example, a frequency band of at least 6 GHz (or 5850, 5900, 5925 MHz, and so on) included in FR1 may include an unlicensed band. The unlicensed band may be used for diverse purposes, e.g., the unlicensed band for vehicle-specific communication (e.g., automated driving).

TABLE 6

| Frequency Range | Corresponding frequency | Subcarrier Spacing |
|---|---|---|
| designation | range | (SCS) |
| FR1 | 410 MHz-7125 MHz | 15, 30, 60 kHz |
| FR2 | 24250 MHz-52600 MHz | 60, 120, 240 kHz |

Claims disclosed in the present specification can be combined in various ways. For example, technical features in method claims of the present specification can be combined to be implemented or performed in an apparatus, and technical features in apparatus claims of the present specification can be combined to be implemented or performed in a method. Further, technical features in method claims and apparatus claims of the present specification can be combined to be implemented or performed in an apparatus. Further, technical features in method claims and apparatus claims of the present specification can be combined to be implemented or performed in a method.

1. A method, comprising:
determining, by a user equipment (UE), an initial beam and an initial beam panel through a cell search, the cell search being a procedure wherein the UE obtains time and frequency synchronization with a cell and detects a cell identity of the cell, based on a primary synchronization signal, a secondary synchronization signal and a physical broadcast channel (PBCH) demodulation reference signal (DMRS) of the cell,
obtaining, by the UE, system information of the cell from a base station,
performing, by the UE, a random access procedure with the base station, wherein the random access procedure comprises: i) transmitting, by the UE, a random access preamble to the base station; ii) receiving a random access response from the base station, iii) performing a scheduled transmission using the scheduled uplink grant in the random access response; and iv) receiving a contention resolution message,
transmitting, by the UE, to the base station UE capability information for beam capability of the UE, wherein the UE capability information comprises beam related information for each of the plurality of beam panels,
reporting, by the UE, to the base station information for a current beam panel among the plurality of beam panels and a current beam index used by the UE in relation to a first transmit-receive point (TRP),
receiving, by the UE, from the base station estimated information for a specific beam panel among the plurality of beam panels and a specific beam index, and
performing, by the UE, a beam search in relation to a second TRP, wherein a beam search procedure for the specific beam panel among the plurality of beam panels is performed with priority.

2. The method of claim 1, wherein the beam related information includes at least one of a beam scan range, a half power beam width (HPBW) of a beam, a beam scan resolution, a bore sight angle of a beam, and a beam index.

3. The method of claim 1, wherein the information for the current beam panel and the current beam index is added to a CSI (channel state information) report.

4. The method of claim 3, wherein the information for the current beam panel and the current beam index is reported periodically.

5. The method of claim 1, wherein the estimated information for the specific beam panel and the specific beam index is included in an RRC (radio resource control) message or DCI (downlink control information).

6. The method of claim 1, wherein the specific beam panel and the specific beam index inform the base station of a beam panel and a beam to be applied to the UE in the future based on the UE capability information, the current beam panel and the current beam index.

7. The method of claim 1, wherein the first TRP and the second TRP are wireless devices controlled by the base station.

8. A user equipment (UE), comprising:
at least one transceiver;
at least one memory; and
at least one processor operably connectable to the at least one transceiver and the at least one memory,
wherein the at least one memory stores instructions that, based on being executed by the at least one processor, cause the at least one processor to perform operations comprising:
determining an initial beam and an initial beam panel through a cell search, the cell search being a procedure wherein the UE obtains time and frequency synchronization with a cell and detects a cell identity of the cell, based on a primary synchronization signal, a secondary synchronization signal and a physical broadcast channel (PBCH) demodulation reference signal (DMRS) of the cell,
obtaining system information of the cell from a base station,
performing a random access procedure with the base station, wherein the random access procedure comprises: i) transmitting, by the UE, a random access preamble to the base station; ii) receiving a random access response from the base station, iii) performing a scheduled transmission using the scheduled uplink grant in the random access response; and iv) receiving a contention resolution message,
transmitting to the base station UE capability information for beam capability of the UE, wherein the UE capability information comprises beam related information for each of the plurality of beam panels,
reporting to the base station information for a current beam panel among the plurality of beam panels and a current beam index used by the UE in relation to a first transmit-receive point (TRP),
receiving from the base station estimated information for a specific beam panel among the plurality of beam panels and a specific beam index, and
performing a beam search in relation to a second TRP, wherein a beam search procedure for the specific beam panel among the plurality of beam panels is performed with priority.

9. The UE of claim 8, wherein the beam related information includes at least one of a beam scan range, a half power beam width (HPBW) of a beam, a beam scan resolution, a bore sight angle of a beam, and a beam index.

10. The UE of claim 8, wherein the information for the current beam panel and the current beam index is added to a CSI (channel state information) report.

11. The UE of claim 10, wherein the information for the current beam panel and the current beam index is reported periodically.

12. The UE of claim 8, wherein the estimated information for the specific beam panel and the specific beam index is included in an RRC (radio resource control) message or DCI (downlink control information).

13. The UE of claim 8, wherein the specific beam panel and the specific beam index inform the base station of a beam panel and a beam to be applied to the UE in the future based on the UE capability information, the current beam panel and the current beam index.

14. The UE of claim 8, wherein the first TRP and the second TRP are wireless devices controlled by the base station.

15. (canceled)

16. (canceled)

17. A method performed by a base station in a wireless communication system, the method comprising:
performing an initial access procedure with a user equipment (UE);
receiving, from the UE, UE capability information for a beam capability of the UE, wherein the UE capability information includes beam related information for each of a plurality of beam panels of the UE;
receiving, from the UE, information for a current beam panel among the plurality of beam panels and a current beam index used by the UE in relation to a first transmit-receive point (TRP), and
transmitting, to the UE, estimated information for a specific beam panel among the plurality of beam panels and a specific beam index,
wherein the specific beam panel and the specific beam index are a beam panel and a beam to be applied to the UE in the future, estimated by the base station based on the UE capability information, the current beam panel and the current beam index, in the relationship between the UE and the second TRP.

18. (canceled)
